(19) United States
(12) Patent Application Publication
(10) Pub. No.: US 2011/0005732 A1
(43) Pub. Date: Jan. 13, 2011

(54) VEHICULAR AIR CONDITIONING APPARATUS

(75) Inventor: Takahiro Seto, Utsunomiya-shi (JP)

Correspondence Address: RANKIN, HILL & CLARK LLP, 38210 GLENN AVENUE, WILLOUGHBY, OH, 44094-7808, US

(73) Assignee: KEIHIN CORPORATION, Tokyo (JP)

(21) Appl. No.: 12/500,745

(22) Filed: Jul. 10, 2009

(51) Int. Cl. B60H 1/00

(52) U.S. Cl. 165/121

(57) ABSTRACT

In a vehicular air conditioning apparatus, a first blower unit is connected by a connection duct to a side portion of a casing, and a second blower unit is connected to another side portion of the casing. A rotation control device for the first blower unit and a rotation control device for the second blower unit are arranged on an exterior side of the connection duct, at a location where a flow passage cross sectional area of the connection duct is maximal. Cooling devices made up of heat radiation fins are disposed on an inner side of the connection duct corresponding to the arranged positions of the rotation control devices.

### BACKGROUND OF THE INVENTION

1. Field of the Invention

The present invention relates to a vehicular air conditioning apparatus mounted in a vehicle for blowing air into a vehicle compartment that has been adjusted in temperature by a heat exchanger, for thereby performing air conditioning of the vehicle compartment.

2. Description of the Related Art

In a vehicular air conditioning apparatus that is mounted in a vehicle, internal and external air is introduced into a casing by a blower, and after cooled air, which has been cooled by an evaporator that forms a cooling means, and heated air, which has been heated by a heater core that forms a heating means, are mixed together in the casing at a predetermined mixing ratio, the mixed air is blown out from a defroster blow-out port, a face blow-out port, or a foot blow-out port, whereby adjustment of temperature and humidity in the vehicle compartment is carried out.

With this type of vehicular air conditioning apparatus, for example, it is known to provide a first blower for the purpose of introducing vehicle compartment air into the casing, and a second blower for the purpose of introducing external air outside of the vehicle compartment into the casing. In such a vehicular air conditioning apparatus, air that is introduced from an internal air introduction port by rotation of the first blower is heated by a first heat exchanger and then is blown into the vehicle compartment through a first air passage from the face blow-out port or the foot blow-out port. In addition, air that is introduced from an external air introduction port by rotation of the second blower is heated by a second heat exchanger and then is blown into the vehicle compartment through a second air passage from the defroster blow-out port. More specifically, a switching operation is performed such that when air is blown out from the face blow-out port or the foot blow-out port, the first blower is driven and air from the interior of the vehicle is introduced, whereas when air is blown out from the defroster blow-out port, the second blower is rotated and external air is introduced.

Further, using separate air conditioning devices having first and second blowers for introducing air, the first blower is arranged facing toward an external air introducing port of a duct, and the second blower is arranged facing toward an interior air introducing port. Additionally, the first blower includes a switching means, which is capable of switching the air that is introduced to the duct by the first blower between interior air and exterior air.

In addition, the air that is introduced to the duct by the first blower is switched between interior air and exterior air by the switching means, and after the air has been adjusted in temperature by a heating means and a cooling means so as to provide a desired temperature together with the air introduced to the duct by the second blower, the air is blown into a desired region in the vehicle compartment through a face blow-out port, a foot blow-out port, or a defroster blow-out port. (See, for example, Japanese Laid-Open Patent Publication No. 05-178068, Japanese Laid-Open Patent Publication No. 06-040236, and Japanese Laid-Open Patent Publication No. 06-191257.) Incidentally, in the vehicular air conditioning apparatus disclosed in Japanese Laid-Open Patent Publication No. 10-217747, it is generally known to provide a rotation control device, which controls the rotation number (i.e., the rotational frequency or RPM) of a blower to change the air-blowing rate. In particular, for stabilizing the control capacity thereof, a heat radiation mechanism is attached to the rotation control device. As one representative type of heat radiation mechanism, heat radiation fins are utilized, which are arranged along an inner wall of a connection passage that interconnects the heat exchanger and the blower.

However, in a vehicular air conditioning apparatus having a structure such as disclosed in Japanese Laid-Open Patent Publication No. 10-217747, in the event that the flow passage cross sectional area of the aforementioned connection passage is small, the size of the heat radiation fins themselves becomes a problem. Specifically, when the ratio of the surface area of the heat radiation fins is large with respect to the flow passage cross sectional area, fluid resistance inside the connection passage increases relatively, and a sufficient amount of fluid required with respect to the heat exchanger (evaporator) disposed downstream therefrom, i.e., a sufficient flow of air, cannot be supplied.

### SUMMARY OF THE INVENTION

A general object of the present invention is to provide a vehicular air conditioning apparatus for carrying out control of temperature separately and independently of front seats and rear seats in a vehicle compartment, which is capable of blowing a sufficient amount of air from a blower to a heat exchanger. Additionally, a vehicular air conditioning apparatus is provided in which, by reducing fluid resistance, energy efficiency is raised, and the comfort of occupants in the vehicle compartment can be enhanced.

The present invention is characterized by a vehicular air conditioning apparatus including a first blower unit, a second blower unit, passages through which air delivered from the first blower unit and the second blower unit passes, and a casing in which a heat exchanger facing toward the passages is disposed, wherein the first blower unit and the second blower unit are connected respectively to the casing by a first connection passage and a second connection passage, and wherein respective rotation control devices for controlling rotation of the first blower unit and the second blower unit are disposed on either one of the first connection passage and the second connection passage which has a greater flow passage cross sectional area.

According to the present invention, among the first connection passage and the second connection passage, rotation control devices for controlling a first blower unit and a second blower unit are disposed in the connection passage having a greater flow passage cross sectional area. Therefore, there is no concern with respect to fluid resistance within the connection passages, and an effect obtained in the maintainability of the vehicular air conditioning apparatus is enhanced.

The above and other objects features and advantages of the present invention will become more apparent from the following descriptions when taken in conjunction with the accompanying drawings in which preferred embodiments of the present invention are shown by way of illustrative example.

### BRIEF DESCRIPTION OF THE DRAWINGS

FIG. 1 is an external perspective view of a vehicular air conditioning apparatus according to a first embodiment of the present invention;

FIG. 2 is an overall cross sectional view of the vehicular air conditioning apparatus shown in FIG. 1;

FIG. 3 is a cross sectional perspective view taken along line III-III of FIG. 1;

FIG. 4 is an enlarged perspective view of a connecting duct that connects a casing and a first blower unit in the vehicular air conditioning apparatus of FIG. 1;

FIG. 5 is a cross sectional view taken along line V-V of FIG. 4;

FIG. 6 is a cross sectional view taken along line VI-VI of FIG. 2;

FIG. 7 is an outline schematic view showing a casing, first and second blower units, and an evaporator that constitute the vehicular air conditioning apparatus of FIG. 1;

FIG. 8A is a correlational diagram showing a correlation between rotational speed and load voltage in a first blower fan;

FIG. 8B is a correlational diagram showing a correlation between rotational speed and load voltage in a second blower fan;

FIG. 9 is an outline block diagram of a controller;

FIG. 10 is a graph of a characteristic curve showing a relationship between a flow rate of air supplied to a casing interior from the first and second blower fans, and electrical power consumption of the first and second blower fans;

FIG. 11 is a flowchart of a drive control sequence of the first and second blower fans;

FIG. 12 is an external perspective view of a vehicular air conditioning apparatus according to a second embodiment of the present invention;

FIG. 13 is a cross sectional view taken along line XIII-XIII of FIG. 12;

FIG. 14 is a cross sectional view taken along line XIV-XIV of FIG. 12;

FIG. 15 is a side view of a first divided casing as seen from an interior side thereof;

FIG. 16 is a side view of a second divided casing as seen from an interior side thereof;

FIG. 17 is an enlarged perspective view of (an evaporator holder of) a connecting duct that fixes an evaporator connected with the first divided casing;

FIG. 18 is an enlarged perspective view of the evaporator holder, which is disposed on an inner wall surface of the second divided casing;

FIG. 19 is a plan view with partial omission showing an evaporator, which is retained on an inner wall surface of the first divided casing;

FIG. 20 is a partial enlarged side view of the evaporator of FIG. 19;

FIG. 21 is an enlarged perspective view of a heater holder disposed on an inside wall surface of the first divided casing;

FIG. 22 is an enlarged perspective view showing the vicinity of a bottom portion of a casing in which a pair of drain ports is formed;

FIG. 23 is an enlarged frontal view of the vicinity of a bottom portion of the casing shown in FIG. 22;

FIG. 24 is an enlarged perspective view of the vicinity of a bottom portion of the casing shown in FIG. 22 as seen from an inner side of the casing;

FIG. 25 is a cross sectional view taken along line XXV-XXV of FIG. 22;

FIG. 26 is a plan view of an evaporator;

FIG. 27 is an enlarged side view showing a condition in which the evaporator of FIG. 26 is retained in an evaporator holder, and further wherein first and second partitioning members are installed thereon;

FIG. 28 is a perspective view with partial omission of the first and second partitioning members shown in FIG. 27;

FIG. 29 is a perspective view with partial omission showing a condition during assembly of the first partitioning member and the second partitioning member;

FIG. 30 is a perspective view with partial omission showing an evaporator installed state, in which the first partitioning member and the second partitioning member shown in FIG. 28 are completely assembled;

FIG. 31 is a cross sectional view with partial omission showing a condition in which a first partitioning member and a second partitioning member are installed on an evaporator;

FIG. 32 is a front view, partially in cross section, showing a condition in which a first partitioning member and a second partitioning member are installed on an evaporator;

FIG. 33 is a plan view of an evaporator according to a modified example, in which a partition plate is installed thereon in place of the first and second partitioning members of FIG. 32;

FIG. 34 is an enlarged perspective view with partial omission showing a condition in which tubes are retained in the partition plate of FIG. 33;

FIG. 35A is a cross sectional view with partial omission showing, during a manufacturing process for the evaporator, a temporarily assembled state in which tubes are inserted through insertion holes of a partition plate;

FIG. 35B is a cross sectional view with partial omission showing, during a manufacturing process for the evaporator, a state in which, from the condition shown in FIG. 35A, the insertion holes are pressed against sides of the tubes to retain the tubes;

FIG. 36 is a plan view of an evaporator according to a modified example in which, in place of the first and second partitioning members of FIG. 32, louverless portions are provided on fins;

FIG. 37 is an enlarged plan view with partial omission showing the vicinity of the louverless portions of FIG. 36;

FIG. 38 is a cross sectional view taken along line XXXVIII-XXXVIII of FIG. 37;

FIG. 39A and FIG. 39B are enlarged plan views showing a modified example o:f the louverless portion;

FIG. 40 is a plan view of a heater core;

FIG. 41 is a schematic cross sectional view of the heater core shown in FIG. 40;

FIG. 42 is a cross sectional view taken along line XLII-XLII of FIG. 40;

FIG. 43A is a side view of the heater core of FIG. 40;

FIG. 43B is an enlarged cross sectional view with partial omission showing a caulked region of a baffle plate and a housing that make up the heater core;

FIG. 44 is a schematic cross sectional view of a heater core according to a modified example in which a cross sectional cross-shaped baffle plate is utilized;

FIG. 45A is a cross sectional view with partial omission taken along line XLVA-XLVA of FIG. 44;

FIG. 45B is a cross sectional view with partial omission taken along line XLVB-XLVB of FIG. 44;

FIG. 46 is a partial cutaway perspective view showing a center plate and a dividing panel disposed inside the casing;

FIG. 47 is an exploded perspective view showing a condition in which a cover is removed from the first and second divided casings, and a defroster damper and a sub-defroster damper are taken out therefrom;

FIG. 48 is a schematic perspective view of the vehicular air conditioning apparatus showing a condition thereof in which a vent duct and a defroster duct are connected respectively to a first vent blow-out port and a defroster blow-out port;

FIG. 49 is a plan view showing the vehicular air conditioning apparatus of FIG. 48;

FIG. 50 is an enlarged perspective view showing the vicinity of a connection duct on which a rotation control device is installed;

FIG. 51 is an enlarged perspective view of the communication duct of FIG. 50, as seen from the side of an opening portion thereof;

FIG. 52 is an enlarged perspective view showing the vicinity of a first rear passage and a third rear passage formed in a lower portion of the casing.

FIG. 53 is an enlarged perspective view of the interior of the casing, showing a modified example of the heater holder shown in FIG. 21;

FIG. 54 is an enlarged perspective view showing a condition in which the heater core is installed in the heater holder of FIG. 53; and

FIG. 55 is a plan view, shown partially in cross section, of the heater core of FIG. 54, as viewed from above.

### DESCRIPTION OF THE PREFERRED EMBODIMENTS

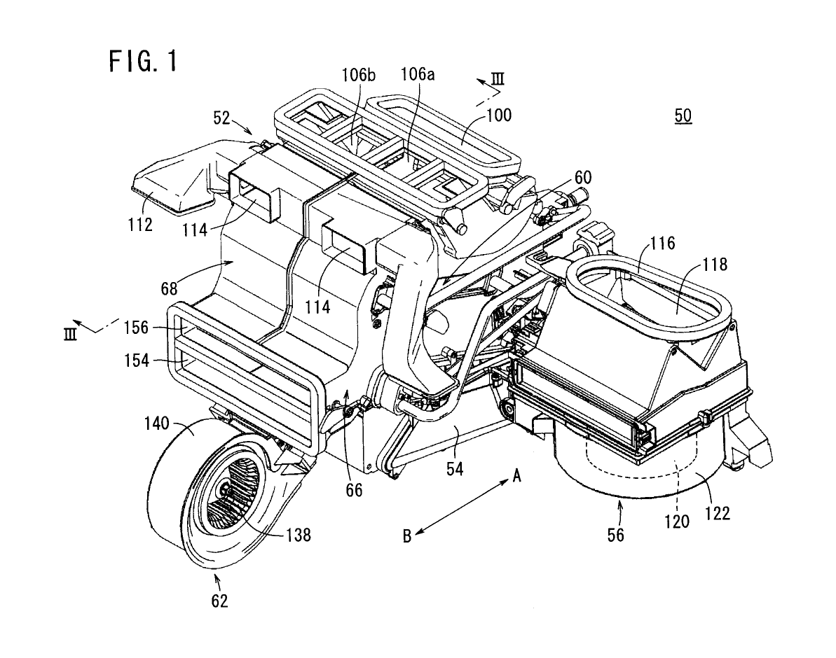

Embodiments of a vehicular air conditioning apparatus shall be presented and explained in detail below with reference to the accompanying drawings. In FIG. 1, reference numeral 50 indicates a vehicular air conditioning apparatus according to a first embodiment of the present invention. The vehicular air conditioning apparatus 50, for example, is installed in a vehicle having three rows of seats arranged along the direction of travel of the vehicle. In the following descriptions, the first row of seats in the vehicle compartment of the vehicle is designated as front seats, the second row of seats is designated as middle seats, and the third row of seats is designated as rear seats.

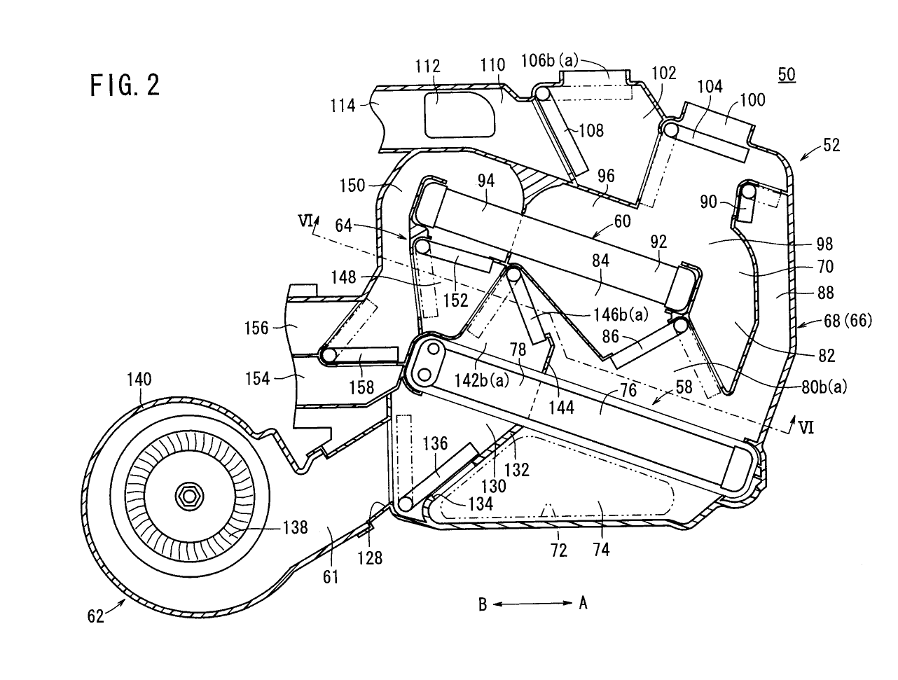

Further, the vehicular air conditioning apparatus 50 is installed so that the righthand side thereof shown in FIG. 2 (in the direction of arrow A) is oriented toward the front side of the vehicle, whereas the lefthand side (in the direction of arrow B) is oriented toward the rear side of the vehicle. The arrow A direction shall be described as a forward direction, whereas the arrow B direction shall be described as a rearward direction.

In the below-described first and second embodiments, inside the casing, plural rotating members made up of dampers or the like are provided, wherein the rotating members are operated by rotational drive sources such as motors or the like. For purposes of simplification, depictions and explanations concerning such rotational drive sources have been omitted.

As shown in FIGS. 1 and 2, the vehicular air conditioning apparatus 50 includes a casing 52 constituted by respective air passages, a first blower unit 56 connected through a connection duct 54 to a side portion of the casing 52 for blowing air toward the front seats of the vehicle, an evaporator (heat exchanger) 58 for cooling air, a heater core (heat exchanger) 60 for heating air that are arranged inside the casing 52, a second blower unit 62 connected to a lower portion of the casing 52 via a connection passage 61 for taking in air from inside the vehicle compartment (interior air) and blowing the air toward the rear seats of the vehicle, and a damper mechanism 64 for switching the flow of air that flows through and inside each of the respective passages.

The casing 52 is constituted by first and second divided casings 66, 68 having substantially symmetrical shapes, wherein a center plate 70 is disposed between the first divided casing 66 and the second divided casing 68. The connection duct 54 is connected on a lower side portion of the first divided casing 66, and a first intake port 72 is formed through which air is supplied from the first blower unit 56. The first intake port 72 communicates with a first front passage 74 disposed on an upstream side of the evaporator 58. The evaporator 58 is disposed so as to straddle between the first divided casing 66 and the second divided casing 68. One end of the evaporator 58 in the forward direction (the direction of arrow A) of the vehicle is inclined downward at a predetermined angle with respect to the other end thereof in the rearward direction of the vehicle.

The evaporator 58 includes a first cooling section 76, which faces the first front passage 74 and cools air supplied from the first front passage 74, and a second cooling section 78, which faces the first rear passage 130 and cools air supplied from the first rear passage 130.

The first cooling section 76 and the second cooling section 78 are separated by a partitioning means, so that air flowing from the first front passage 74 into the evaporator 58 and air flowing from the first rear passage 130 into the evaporator 58 do not mix together mutually inside the evaporator 58.

On the other hand, on a downstream side of the evaporator 58, second front passages 80a, 80b are formed, to which air having passed through the first cooling section 76 is supplied. Above the second front passages 80a, 80b, a third front passage 82 and a fourth front passage 84 are formed in a branching or bifurcated manner. Further, in the second front passages 80a, 80b, a first air mixing damper 86 is rotatably disposed so as to face toward the branching portion of the third front passage 82 and the fourth front passage 84. Additionally, by rotation of the first air mixing damper 86, the blowing condition and blowing rate of cooled air that has passed through the evaporator 58 into the third front passage 82 and the fourth front passage 84 is adjusted. The third front passage 82 is arranged on the forward side (the direction of arrow A), whereas the fourth front passage 84 is arranged on the rearward side (the direction of arrow B) of the casing 52. The heater core 60 is disposed on a downstream side of the fourth front passage 84.

Further, on the forward side (in the direction of arrow A) of the third front passage 82, a bypass passage 88 is formed, which extends along the third front passage 82 and supplies air to a later-described mixing section 98 downstream from the evaporator 58, and a bypass damper 90 is disposed on a downstream side of the bypass passage 88. The bypass passage 88 is provided to supply cool air cooled by the evaporator 58 directly to the downstream side under a switching action of the bypass damper 90.

The heater core 60, similar to the evaporator 58, is disposed so as to straddle between the first divided casing 66 and the second divided casing 68. One end of the heater core 60 in the forward direction (the direction of arrow A) of the vehicle is inclined downward at a predetermined angle with respect to the other end thereof in the rearward direction of the vehicle. The heater core 60 includes a first heating section 92, which faces the fourth front passage 84 and heats air supplied from the fourth front passage 84, and a second heating section 94, which faces the third rear passage 148 and heats air supplied from the third rear passage 148. The first heating section 92 and the second heating section 94 are separated by a partitioning means, so that air flowing from the fourth front passage 84 to the heater core 60 and air flowing from the third rear passage 148 to the heater core 60 do not mix together mutually inside the heater core 60.

On the downstream side of the heater core 60, a fifth front passage 96 is formed. The fifth front passage 96 extends in the forward direction, and at a location that merges downstream from the third front passage 82, the mixing section 98 is formed, in which cooled air supplied through the third front passage 82 and warm air supplied through the fifth front passage 96 are mixed. A defroster blow-out port 100 opens upwardly of the mixing section 98, and to the side of the mixing section 98, a rearward-extending sixth front passage 102 is formed.

Further, in the mixing section 98, a defroster damper 104 is rotatably disposed, facing the defroster blow-out port 100. By rotation of the defroster damper 104, the blowing state of air into the defroster blow-out port 100 and the sixth front passage 102 is switched, and the blowing rate thereof is adjusted.

In the sixth front passage 102, a first vent blow-out port 106 opens upwardly, and a vent damper 108 is rotatably disposed facing toward the first vent blow-out ports 106a, 106b, and communicates with a seventh front passage 110, which extends further rearward. By rotation of the vent damper 108, the blowing state of air is switched when air is blown from the mixing section 98 to the first vent blow-out port 106 and the seventh front passage 110, and further, the blowing rate of the air is capable of being adjusted.

The defroster blow-out port 100 and the first vent blow-out ports 106a, 106b of the casing 52 respectively open upward. The defroster blow-out port 100 is arranged on a forward side (in the direction of arrow A), whereas the first vent blow-out ports 106a, 106b are arranged substantially centrally in the casing 52 on the rearward side (in the direction of arrow B), with respect to the defroster blow-out port 100.

On a downstream side of the seventh front passage 110, a first heat passage 112 is connected, which extends in the widthwise direction of the casing 52 and blows air through a non-illustrated first heat blow-out port in the vicinity of the feet of passengers in the front seats in the vehicle compartment. Together therewith, a second heat passage 114 is connected, which extends rearward in the casing 52 and blows air through a second heat blow-out port (not shown) in the vicinity of the feet of passengers in the middle seats inside the vehicle compartment.

The first blower unit 56 includes an intake damper 118 in which a duct 116 for introducing external air is disposed in an inlet opening thereof, for carrying out switching of internal and external air, and a first blower fan 120 for supplying to the interior of the casing 52 air (external air or internal air) that is taken in from the duct 116. A blower case 122 in which the first blower fan 120 is accommodated communicates with the interior of the casing 52 via a connection duct 54 connected to the first intake port 72. The first blower fan 120 is controlled by a blower motor 121, which is driven under the control of a later-described rotation control device 124a.

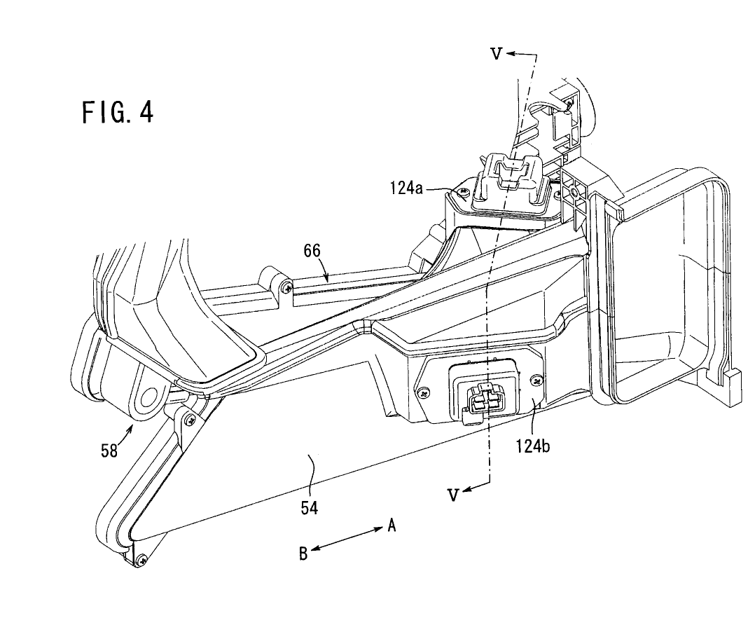

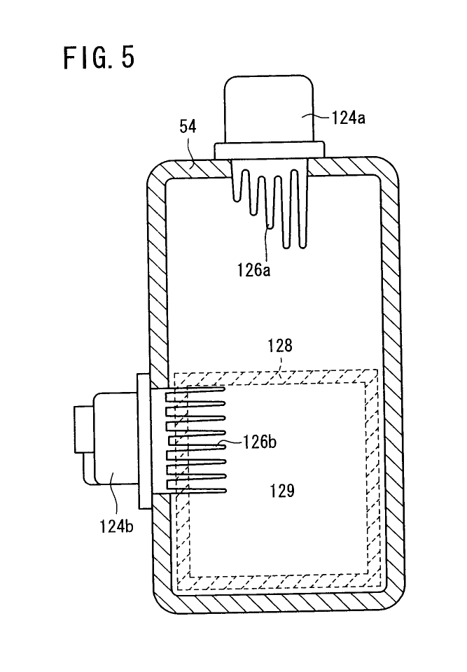

Further, the connection duct 54 has a shape in which the cross sectional area of a passage thereof is greater than the connection passage 61 of a later-mentioned second blower unit 62. Further, as shown in FIGS. 4 and 5, the connection duct 54 is formed in a tubular shape having a substantially rectangular shape in cross section, wherein two rotation control devices 124a, 124b are installed on wall portions thereof. The rotation control devices 124a, 124b are capable of controlling the air-blowing rate to the inside of the casing 52, by controlling respectively the rotation number (RPM) of the first blower fan 120 and the second blower fan 138. The rotation control devices 124a, 124b are arranged at positions where the fluid passage cross sectional area thereof is maximal inside the connection duct 54. In addition, the rotation control devices 124a, 124b are arranged perpendicularly to each other, and a plurality of heat radiation fins 126a, 126b, made of aluminum for example, are mounted so as to project into the passage of the connection duct 54. Specifically, by placing the heat radiation fins 126a, 126b in contact with air that flows inside the connection duct 54 to disturb the air, since heat generated by the rotation control devices 124a, 124b can suitably be dissipated via the heat radiation fins 126a, 126b, the rotation control devices 124a, 124b can be cooled effectively.

In this manner, air supplied from the first blower unit 56 is introduced to the interior of the casing 52 through the connection duct 54 and the first intake port 72, and by rotating actions of the first air mixing damper 86, the defroster damper 104, the vent damper 108 and the bypass damper 90, which collectively make up the damper mechanism 64, air is selectively supplied through the first through seventh front passages 74, 80, 82, 84, 96, 102, 110, and the bypass passage 88 into the defroster blow-out port 100, the first vent blow-out port 106 and the first and second heat passages 112, 114, which are capable of blowing air to the front and middle seats in the vehicle.

On the other hand, on a lower portion of the casing 52, a second intake port 128 through which air is supplied from the second blower unit 62 is formed on a rearward side (in the direction of arrow B) perpendicular to the first intake port 72, and is connected to the connection passage 61 between the second blower unit 62 and the casing 52. The second intake port 128 opens at a position on an upstream side of the evaporator 58 and communicates with the first rear passage 130. As shown by the broken line in FIG. 5, the passage cross sectional area 129 of the second intake port 128 is formed to be smaller than the passage cross sectional area of the connection duct 54, which is connected to the first blower unit 56.

Stated otherwise, the passage cross sectional area of the connection duct 54 in which the rotation control devices 124a, 124b are installed is set to be greater than the passage cross sectional area of the second intake port 128, which is connected to the second blower unit 62.

Further, the first rear passage 130 is separated from the first front passage 74 by a first dividing wall 132, and a rotatable ventilation switching damper 136 is provided between a communication opening 134 formed in the first dividing wall 132 and the second intake port 128. In addition, in the case that a mode is selected in which blowing of air from the second blower unit 62 is halted and blowing of air only from the first blower unit 56 is carried out, by blocking the second intake port 128 by the ventilation switching damper 136 (i.e., the state shown by the two-dot-dash line in FIG. 2), backflowing of air into the second blower unit 62 can be prevented when a portion of the air supplied from the first blower unit 56 passes through the interior of the evaporator 58 and the heater core 60, and is leaked out to the side of the first through fourth rear passages 130, 142a, 142b, 148, 150. Consequently, noise generated at the second blower unit 62 caused by backflowing of air can be prevented, and air is prevented from reaching the second blower unit 62 and from being blown out into the vehicle compartment. In other words, blowing of unnecessary air into the vehicle compartment is averted, and imparting a sense of discomfort to occupants in the vehicle can be avoided.

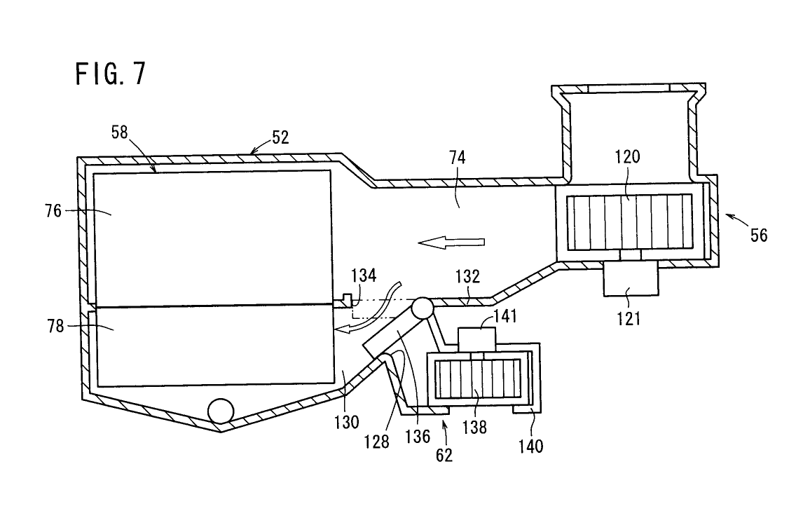

Further, as shown in FIG. 7, by rotating the ventilation switching damper 136 to the side of the second intake port 128 and opening the communication opening 134, a portion of the air supplied to the first front passage 74 can be supplied to the side of the first rear passage 130. Driving control of the ventilation switching damper 136 shall be described subsequently.

The second blower unit 62 includes a second blower fan 138 that takes in air (internal air) from the vehicle compartment and supplies the intake air to the interior of the casing 52. A blower case 140 in which the second blower fan 138 is accommodated is connected to the second intake port 128 of the casing 52 and communicates with the first rear passage 130. The second blower fan 138, similar to the first blower fan 120, is controlled by a second blower motor 141, which is driven under the control of the rotation control device 124b.

On a downstream side of the first rear passage 130, second rear passages 142a, 142b are formed to which air that has passed through the second cooling section 78 of the evaporator 58 is supplied. The second rear passages 142a, 142b are separated from the second front passages 80a, 80b by a second dividing wall 144, and the second dividing wall 144 extends to the partitioning means of the evaporator 58. Owing thereto, on a downstream side of the evaporator 58, air that has passed through the first rear passage 130 and flows to the second cooling section 78 of the evaporator 58 does not intermix mutually with air that has passed through the first front passage 74 and flows to the first cooling section 76 of the evaporator 58.

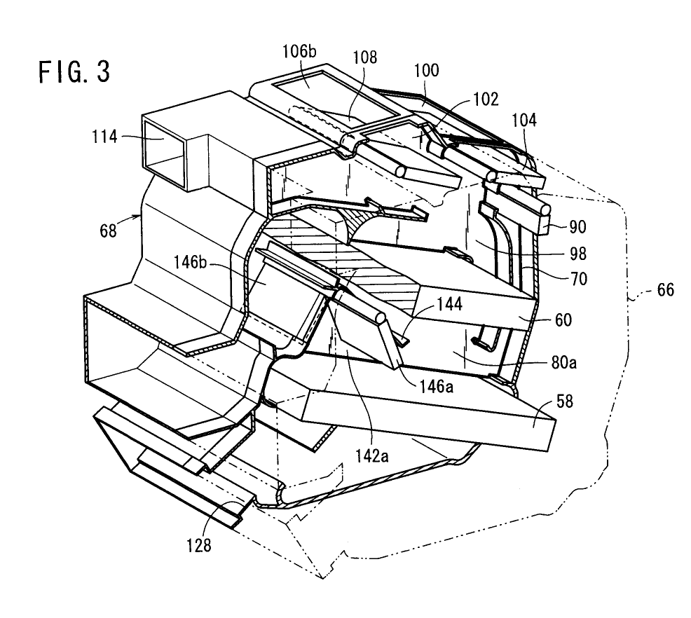

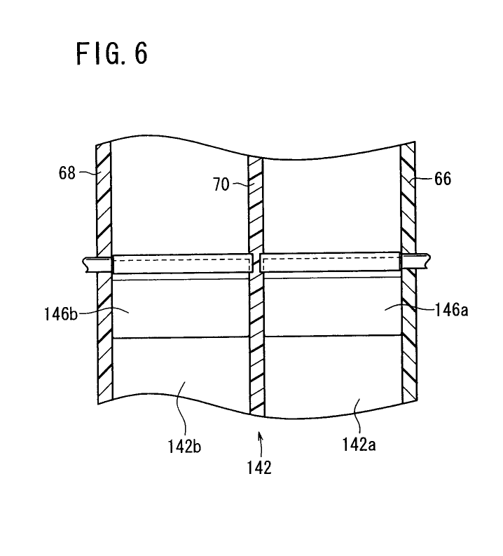

Herein, as shown in FIG. 3, the second rear passages 142a, 142b, the second front passages 80a, 80b and the first vent blow-out ports 106a, 106b are separated respectively on sides of the first and second divided casings 66, 68 about the center plate 70, which is disposed in the center of the casing 52, thereby forming the second rear passage 142a and the second rear passage 142b, the second front passage 80a and the second front passage 80b, and the first vent blow-out port 106a and the first vent blow-out port 106b. Furthermore, as shown in FIG. 6, a pair of communication switching dampers 146a, 146b, which are capable of switching a communication state between the second front passage 80a and the second front passage 80b, are disposed in the second rear passage 142a and the second rear passage 142b, respectively, wherein one of the communication switching dampers 146a and the other of the communication switching dampers 146b are rotatably controlled separately and independently from each other.

In addition, by rotation of the pair of communication switching dampers 146a, 146b, the second rear passages 142a, 142b for blowing air to the middle seats and rear seats in the vehicle compartment are placed in communication mutually with the second front passages 80a, 80b for blowing air to the front seats in the vehicle compartment, such that, for example, by changing the rotation amount of one of the communication switching dampers 146a and the rotation amount of the other communication switching damper 146b, the blowing rate and temperature of air that is blown to the passenger side of the front seats from the first vent blow-out port 106a through the second front passage 80a, and the blowing rate and temperature of air that is blown to the driver's side of the front seats from the first vent blow-out port 106b through the second front passage 80b, can be controlled separately from each other.

The third rear passage 148 facing the heater core 60 is formed on the downstream side of the second rear passages 142a, 142b. One side of the heater core 60 opens into the third rear passage 148, whereas another side thereof opens onto the side of an adjacent fourth rear passage 150. In addition, a second air mixing damper 152, which mixes at a predetermined mixing ratio the cool air and warm air supplied to the third rear passage 148, thereby producing mixed air, is disposed rotatably in the third rear passage 148. The second air mixing damper 152 switches the communication state between the third rear passage 148 and the upstream or downstream side of the fourth rear passage 150, which is connected to the downstream side of the heater core 60. Consequently, air cooled by the evaporator 58 and supplied to the third rear passage 148, and air heated by the heater core 60 and that flows to the fourth rear passage 150, are mixed at a predetermined mixing ratio inside the fourth rear passage 150 by rotation of the second air mixing damper 152, and are blown out therefrom.

More specifically, an intermediate location of the fourth rear passage 150 functions as a mixing section, for mixing cool air and warm air that is blown to the middle seats and rear seats in the vehicle.

The fourth rear passage 150 bends so as to circumvent the other end of the heater core 60 and extends to communicate with fifth and sixth rear passages 154, 156, which branch on a downstream side thereof. A rotatable mode switching damper 158 is disposed at the branching location of the fifth and sixth rear passages 154, 156. The communication state between the fourth rear passage 150 and the fifth and sixth rear passages 154, 156 is switched by rotation of the mode switching damper 158.

The fifth and sixth rear passages 154, 156 extend respectively in the rearward direction (the direction of arrow B) of the vehicle. The fifth rear passage 154 communicates with a second vent blow-out port (not shown) for blowing air in the vicinity of the faces of passengers in the middle seats in the vehicle. On the other hand, the sixth rear passage 156 communicates with third and fourth heat blow-out ports (not shown) for blowing air in the vicinity of the feet of passengers riding in the middle and rear seats.

More specifically, air supplied from the second blower unit 62 is introduced to the interior of the casing 52 through the second intake port 128, and under rotating actions of the second air mixing damper 152 and the mode switching damper 158, which make up the damper mechanism 64, the air passes through the first through sixth rear passages 130, 142a, 142b, 148, 150, 154, 156 and is supplied selectively to the second vent blow-out port, and the third and fourth heat blow-out ports (not shown), which are capable of blowing air to the middle and rear seats in the vehicle.

The aforementioned second through sixth front passages 80, 82, 84, 96, 102, the bypass passage 88 and the second rear passages 142 are disposed respectively so as to straddle between the first divided casing 66 and the second divided casing 68. However, as easily understood, these passages also are divided by the center plate 70, which is disposed in the center of the casing 52.

The vehicular air conditioning apparatus 50 according to the first embodiment of the present invention is basically constructed as described above. Next, operations and effects of the invention shall be explained.

First, when operation of the vehicular air conditioning apparatus 50 is started, the first blower fan 120 of the first blower unit 56 is rotated under the control of the rotation control device 124a, and air (interior or exterior air) that is taken in through the duct 116 or the like is supplied to the first front passage 74 of the casing 52 through the connection duct 54. Simultaneously, air (interior air), which is taken in by rotation of the second blower fan 138 of the second blower unit 62 under the control of the rotation control device 124b, is supplied to the first rear passage 130 from the blower case 140 while passing through the second intake port 128. In the following descriptions, air supplied to the interior of the casing 52 by the first blower fan 120 shall be referred to as “first air,” and air supplied to the interior of the casing 52 by the second blower fan 138 shall be referred to as “second air.”

The first air and the second air supplied to the interior of the casing 52 are each cooled by passing respectively through the first and second cooling sections 76, 78 of the evaporator 58, and flow respectively as chilled air to the second front passage 80 and the second rear passage 142, in which the first and second air mixing dampers 86, 152 are disposed. In this case, because the interior of the evaporator 58 is separated into the first cooling section 76 and the second cooling section 78 by the partitioning means, the first air and the second air do not intermix with one another.

In the case that a vent mode, for example, is selected by a passenger for blowing air in the vicinity of the faces of passengers, the first air mixing damper 86 is rotated to an intermediate position between the third front passage 82 and the fourth front passage 84, whereupon the first air (cooled air) supplied to the third front passage 82 flows into the mixing section 98, while the first air supplied to the fourth front passage 84 is heated by passing through the heater core 60 to become heated air, and flows into the mixing section 98 through the fifth front passage 96, whereby the first cooled air and the first heated air are mixed together.

The first air (mixed air), which is made up of the cool air and heated air mixed in the mixing section 98, passes through the sixth front passage 102 and is blown in the vicinity of the faces of passengers in the vehicle compartment from the first vent blow-out ports 106a, 106b, due to the fact that the defroster blow-out port 100 is blocked by the defroster damper 104, and further, the opening of the seventh front passage 110 is blocked by the vent damper 108.

On the other hand, the second air mixing damper 152 is rotated to an intermediate position in the interior of the third rear passage 148, whereupon the second air (cool air) supplied to the third rear passage 148 is heated by passing through the heater core 60 to become heated air, and flows to the downstream side through the fourth rear passage 150. Together therewith, cooled second air is supplied directly into the fourth rear passage 150 from the opening of the third rear passage 148, is mixed together with the heated second air, and flows to the downstream side. In addition, under a switching action of the mode switching damper 158, the second air (mixed air) passes through the fifth rear passage 154 and is blown in the vicinity of the faces of passengers in the middle seats in the vehicle compartment from the second vent blow-out port (not shown).

Next, in the case that a bi-level mode is selected for blowing air in the vicinity of the faces and feet of passengers in the vehicle compartment, the first air mixing damper 86 is rotated somewhat toward the side of the third front passage 82, whereas the vent damper 108 is placed in an intermediate position, rotated somewhat to the side of the first vent blow-out port 106 compared to the case of the vent mode. Additionally, the first air that has passed through the evaporator 58 is supplied directly into the mixing section 98 via the bypass passage 88, is mixed in the mixing section 98 with the first air (mixed air) that is supplied through the third and fifth front passages 82, 96, and is blown in the vicinity of the faces of passengers from the first vent blow-out port 106. Further, a portion of the first air (mixed air), which flows to the sixth front passage 102 from the mixing section 98, passes through the sixth and seventh front passages 102, 110 and is supplied respectively to the first and second heat passages 112, 114, whereby the air is blown in the vicinity of the feet of passengers in the front and middle seats in the vehicle compartment from the first and second heat blow-out ports (not shown).

At the same time, the second air mixing damper 152 is rotated somewhat in a direction away from the heater core 60, and the mode switching damper 158 is rotated from the position closing the sixth rear passage 156 to an intermediate position between the fifth rear passage 154 and the sixth rear passage 156. In addition, as for the second air, warm air heated by the heater core 60 and cooled air, which is supplied to the fourth rear passage 150 through the opening from the third rear passage 148, are mixed together and blown as mixed air from the fifth rear passage 154, through the second vent blow-out port, and in the vicinity of the faces of passengers riding in the middle seats in the vehicle compartment, while also being blown from the sixth rear passage 156, past the third and fourth heat blow-out ports, and in the vicinity of the feet of passengers riding in the middle and rear seats in the vehicle compartment.

Next, in the case that the heat mode is selected for blowing air in the vicinity of the feet of passengers in the vehicle compartment, the first air mixing damper 86 is rotated further to the side of the third front passage 82 compared to the case of the bi-level mode, while the defroster damper 104 and the vent damper 108 are rotated respectively to block the defroster blow-out port 100 and the first vent blow-out port 106. Consequently, the first air (mixed air), which was mixed in the mixing section 98, passes through the sixth and seventh front passages 102, 110 and flows rearward to be supplied respectively to the first and second heat passages 112, 114, and is blown in the vicinity of the feet of passengers in the front and middle seats in the vehicle compartment from the non-illustrated first and second heat blow-out ports.

On the other hand, the second air mixing damper 152 is rotated further toward the side of the opening compared to the case of the bi-level mode, and further, the mode switching damper 158 is positioned to block the fifth rear passage 154. Consequently, the second air (mixed air), which is mixed in the fourth rear passage 150, passes from the fourth rear passage 150, through the sixth rear passage 156, and is supplied to the third and forth heat blow-out ports, whereby the air is blown in the vicinity of the feet of passengers in the middle and rear seats in the vehicle compartment.

Next, an explanation shall be made concerning a heat-defroster mode for blowing air in the vicinity of the feet of passengers in the vehicle compartment, as well as for blowing air in the vicinity of a front window for eliminating fog (condensation) from the front window. In the event that the heat-defroster mode is selected, the defroster damper 104 is rotated in a direction to separate from the defroster blow-out port 100, so as to assume an intermediate position between the opening of the sixth front passage 102 and the defroster blow-out port 100, and together therewith, the first vent blow-out ports 106a, 106b is blocked by the vent damper 108 (i.e., the condition of the two-dot-dash line shown in FIG. 2). Consequently, a portion of the first air (mixed air), which is mixed in the mixing section 98, passes through the defroster blow-out port 100 and is blown in the vicinity of the front window of the vehicle, while another portion of the first air flows past the sixth and seventh front passages 102, 110 and is blown in the vicinity of the feet of passengers in the front and middle seats in the vehicle compartment from the first and second heat passages 112, 114 and the first and second heat blow-out ports (not shown).

On the other hand, in the heat-defroster mode, in the case that second air is blown toward the middle seats and rear seats of the vehicle compartment, since this mode is the same as the heat mode discussed above, detailed explanations thereof shall be omitted.

Lastly, the defroster mode for blowing air only in the vicinity of the front widow for eliminating fog (condensation) from the front window in the vehicle shall be described. In this case, the defroster damper 104 is rotated to separate from the defroster blow-out port 100 while the opening of the sixth front passage 102 is blocked, and the first air (mixed air) is supplied from the mixing section 98 to the opened defroster blow-out port 100 and is blown in the vicinity of the front window in the vehicle. In this case, the defroster mode can be handled solely by blowing first air supplied only from the first blower unit 56, without driving the second blower unit 62.

Further, at this time, the ventilation switching damper 136 is rotated to separate away from the first dividing wall 132 thereby opening the communication passage 134, and the communication switching damper 146a(b) is rotated to place the second rear passage 142a(b) and the second front passage 80a(b) in communication, so that a portion of the first air supplied to the first front passage 74 is supplied to the side of the first rear passage 130. As a result, even in the case that the second blower unit 62 is not driven and second air is not supplied to the second rear passages 142a, 142b, since a portion of the first air can be made to pass through the second cooling section 78 of the evaporator 58, freezing of the evaporator 58 can be prevented.

Furthermore, by rotation of the ventilation switching damper 136, the second rear passage 142a(b) becomes blocked, whereby noises, which are produced by inflow of the first air into the second blower unit 62, can be prevented.

In each of the blowing modes excluding the aforementioned defroster mode, the first blower fan 120 and the second blower fan 138 are driven simultaneously, so that the first and second air are supplied at desired flow rates to the interior of the casing 52. In this case, in the present embodiment, drive controls for the first blower fan 120, the second blower fan 138 and the ventilation switching damper 136 are carried out through a controller 160 (described later), corresponding to a first air supply rate (blowing rate) and a second air supply rate (blowing rate) required during each of the blowing modes. First, the drive control for the ventilation switching damper 136 shall be explained below.

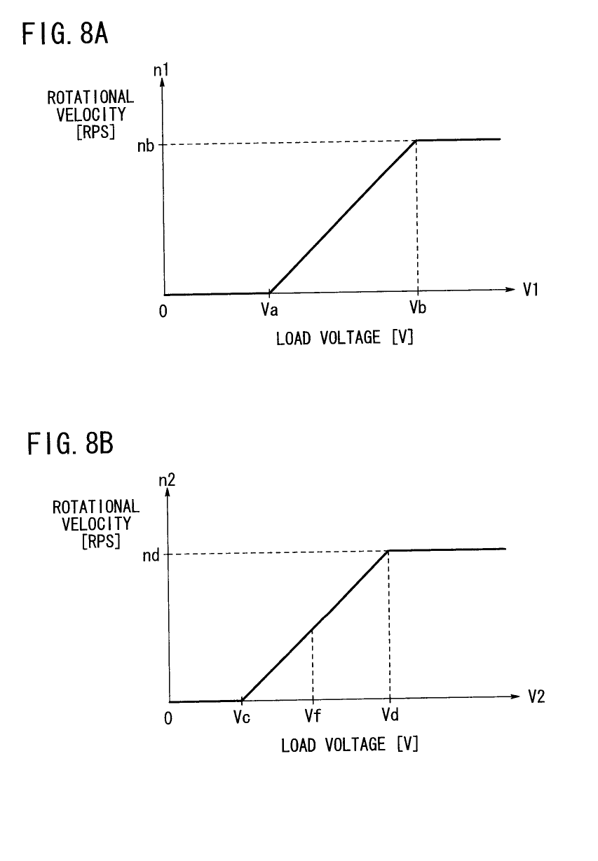

Although the blowing rate of the first air is proportional to the rotation number (RPS), or more specifically the rotational velocity n1, of the first blower fan 120, the rotational velocity n1 can be determined by a load voltage V1, which is supplied from a later-described power source 176 and through a first fan driver 170 to the first blower fan 120. FIG. 8A shows a relationship between the rotational velocity n1 of the first blower fan 120 and the load voltage V1 supplied to the first blower fan 120. In this case, a drive voltage of the first blower fan 120 is designated by Va, whereas the maximum rated voltage of the first blower fan 120 is designated by Vb. In the case that the voltage V1 is less than Va, the first blower fan 120 is not rotated. Further, in the case that the voltage V1 is greater than Vb, the voltage V1 is stepped down to the voltage Vb by a voltage protection circuit made up of a non-illustrated regulator or the like, whereby the first blower fan 120 is rotated at the same rotational velocity nb as when the voltage Vb is applied. As a result, imposition of a voltage on the first blower fan 120 that exceeds the maximum rated voltage is prevented, so that damage is not caused to the first blower fan 120 and the first fan driver 170.

Also, in the case that the second blower fan 138 is energized for blowing air, analogous to the case of the first blower fan 120, as shown in FIG. 8B, the load voltage supplied to the second fan driver 172 from the later-mentioned power source 176 is designated by V2, the rotational velocity is designated by n2, the drive voltage is designated by Vc, the maximum rated voltage is designated by Vd, and the rotational velocity when the voltage Vd is applied is designated by nd. However, since control is carried out in the same manner as the control for the first blower fan 120, detailed explanations thereof have been omitted.

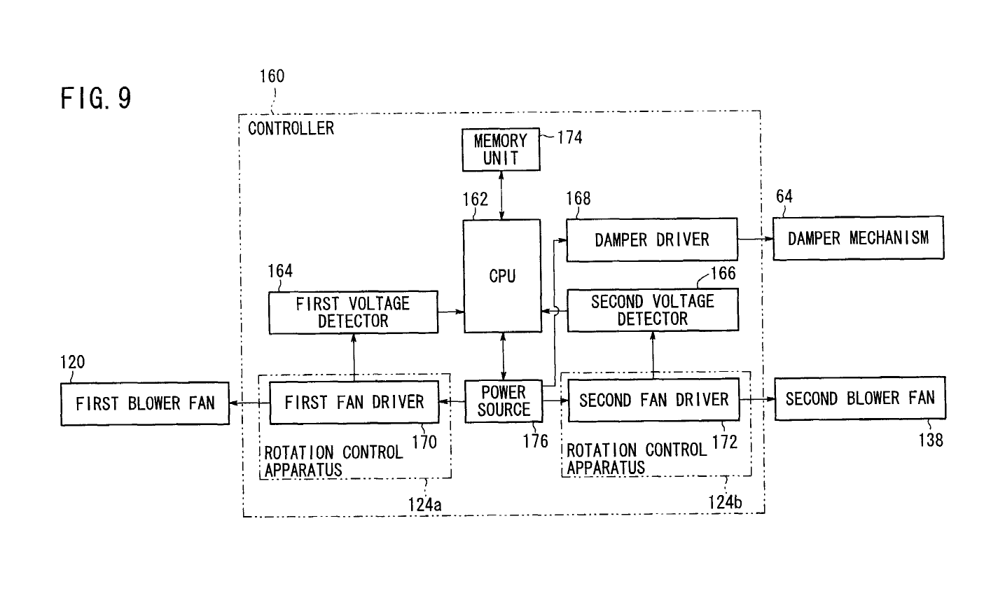

As shown in FIG. 9, the controller 160 includes a CPU (Central Processing Unit) 162 that serves as a main controller, a first fan driver 170 for driving the first blower fan 120, a second fan driver 172 for driving the second blower fan 138, a first voltage detector 164 for detecting the load voltage V1 supplied to the first fan driver 170, a second voltage detector 166 for detecting the load voltage V2 supplied to the second fan driver 172, a damper driver 168 for driving the damper mechanism 64, a memory unit 174 constituted by a RAM (Random Access Memory) and a ROM (Read Only Memory), and a power source 176 that supplies power to the damper driver 168 and to the first and second fan drivers 170, 172. Each of the aforementioned functional elements are implemented by the CPU 162, which reads in a program, and by effecting software processing in cooperation with the memory unit 174. The first fan driver 170 may be incorporated into a rotation control device 124a, and the second fan driver may be incorporated into a rotation control device 124b.

A first air flow rate A1, which represents a flow rate of the first air corresponding to one rotation of the first blower fan 120, a second air flow rate A2, which represents a flow of the second air corresponding to one rotation of the second blower fan 138, an electrical resistance R1 of the first blower fan 120, and an electrical resistance R2 of the second blower fan 138 are stored beforehand in the memory unit 174. However, the data stored in the memory unit 174 is not necessarily limited to these items.

Moreover, the first voltage detector 164, the second voltage detector 166, the damper driver 168, the first fan driver 170, the second fan driver 172, the memory unit 174 and the power source 176 may be functionally integrated into the CPU 162.

In the case that data of the load voltage V2 received by the CPU 162 is such that V2<Vc, i.e., in the case that the second blower fan 138 is not rotated (n2=0), the ventilation switching damper 136 constituting the damper mechanism 64 is rotated by an instruction from the CPU 162, and by power being supplied to the damper driver 168 from the power source 176, whereby the second intake port 128 is blocked (see FIG. 7). Consequently, by supplying first air from the first front passage 74, through the communication opening 134, past the first rear passage 130, and to the second cooling section 78, freezing and adhering of water droplets, which occur on the surface of the second cooling section 78, can be prevented. Further, by blocking the second intake port 128, noises in the vehicle compartment, the possibility of which is caused by air inside the casing 52 backflowing and reaching the second blower fan 138 of the second blower unit 62, can be reduced insofar as possible.

Further, concerning the load voltage V2, in the case that a predetermined voltage value Vf (where Vc<Vf<Vd, as shown in FIG. 8B) is set beforehand in the memory unit 174, and the data of the load voltage V2 received by the CPU 162 is such that Vc≦V2<Vf, i.e., in the case that the rotational velocity n2 of the second blower fan 138 is set slowly, the CPU 162 sends an instruction to the damper driver 168, whereby the ventilation switching damper 136 is rotated corresponding to the load voltage V2. Accordingly, the communication opening 134 is opened, and a portion of the first air from the first blower fan 120 is delivered from the first front passage 74, past the communication opening 134 and the first rear passage 130, and to the second cooling section 78 of the evaporator 58, and furthermore, the second air from the second blower fan 138 also is supplied past the second intake port 128 and from the first rear passage 130 to the second cooling section 78, whereby freezing and adhering of water droplets, which occur on the surface of the second cooling section 78, can be prevented (see FIG. 7).

Further, in the case that the data of the load voltage V2 received by the CPU 162 is such that Vf≦V2≦Vd, i.e., in the case that the rotational velocity n2 of the second blower fan 138 is sufficiently assured, the CPU 162 sends an instruction to the damper driver 168, thereby rotating the ventilation switching damper 136 to block the communication opening 134 (see FIG. 7).

Moreover, in the case that the data of the load voltage V1 received by the CPU 162 is such that V1=Vb, the CPU 162 constantly sends an instruction to the damper driver 168, so that the ventilation switching damper 136 is rotated to block the communication opening 134 (see FIG. 7). That is, in the case that V1=Vb, for example in the case of the defroster mode, the first blower fan 120 is operated at maximum power to rapidly introduce external air, so that fog (condensation) is eliminated from the front window of the vehicle, and the visibility of occupants in the vehicle is suitably assured.

Next, an explanation shall be made concerning drive controls for the first blower fan 120 and the second blower fan 138.

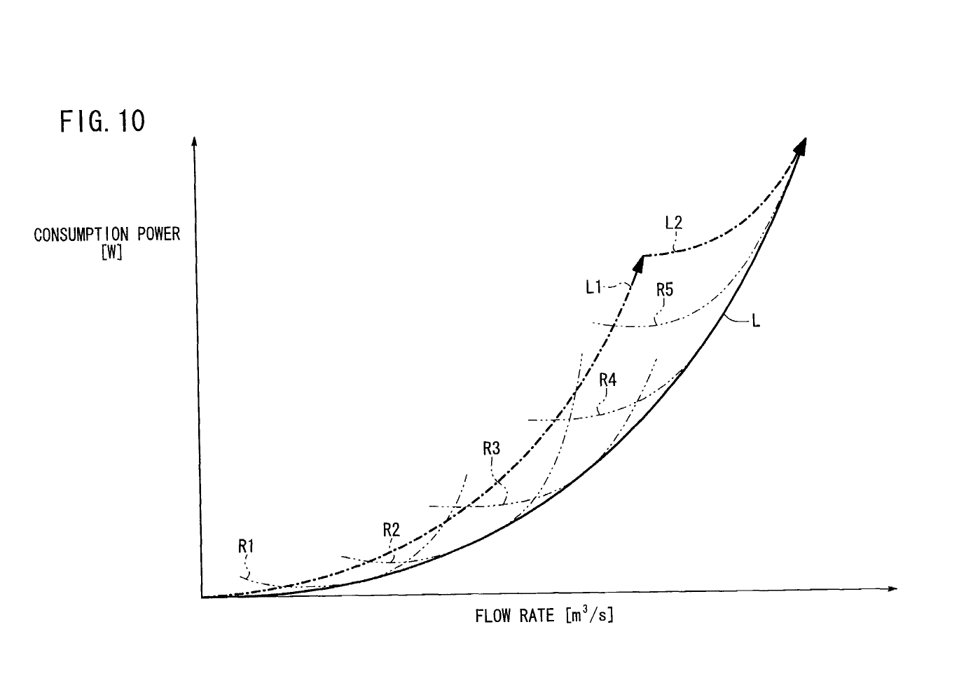

The drive controls for the first blower fan 120 and the second blower fan 138 are carried out so that, while the sum of the supply rate (flow rate of air) of the first air and the supply rate (flow rate of air) of the second air is maintained constant, the sum of the first power consumption W1 required to drive the first blower fan 120 and the second power consumption W2 required to drive the second blower fan 138 is minimized (refer to the solid line L in FIG. 10). Herein, the flow rate of air when the first blower fan 120 is driven independently is the product of the first air flow rate A1 and the rotational speed n1. Further, as shown in FIG. 8A, the rotational velocity n1 is proportional to the load voltage V1. Similarly, concerning the second blower fan 138, the flow rate of air when the second blower fan 138 is driven independently can be regarded as the product of the second air flow rate A2 and the rotational speed n2, and as shown in FIG. 8B, the rotational velocity n2 is proportional to the load voltage V2.

Further, the first power consumption W1 of the first blower fan 120 is proportional to the square of the load voltage V1, and inversely proportional to the electrical resistance R1. Similarly, the second power consumption W2 of the second blower fan 138 is proportional to the square of the load voltage V2, and inversely proportional to the electrical resistance R2.

The drive voltage Va of the first blower fan 120, the maximum rated voltage Vb, the rotational velocity nb when the voltage Vb is applied, the first air flow rate A1 and the electrical resistance R1 can be regarded as fixed values by the characteristics of the first blower fan 120. Furthermore, the drive voltage Vc of the second blower fan 138, the maximum rated voltage Vd, the rotational velocity nd when the voltage Vd is applied, the second air flow rate A2 and the electrical resistance R2 can be regarded as fixed values by the characteristics of the second blower fan 138. Accordingly, the consumption power W1 and the flow rate of air when the first blower fan 120 is driven independently is determined by the load voltage V1, and further, the consumption power W2 and the flow rate of air when the second blower fan 138 is driven independently is determined by the load voltage V2. That is, the drive controls for the first blower fan 120 and the second blower fan 138 are affected by controlling the load voltages V1, V2.

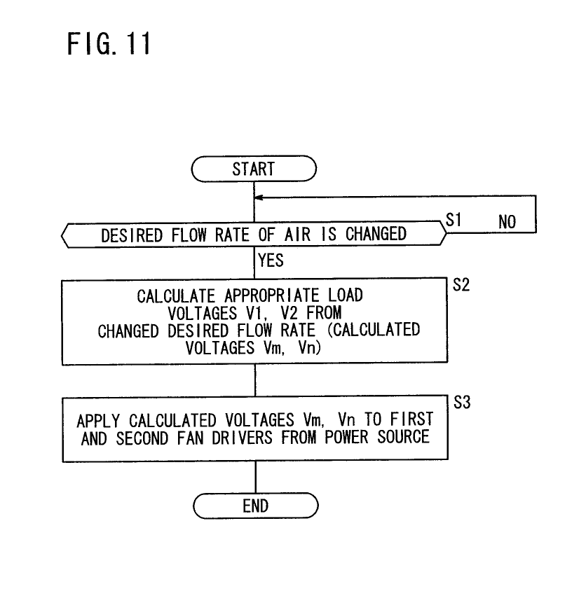

Control of the load voltages V1, V2 shall be described below with reference to FIG. 11. As described previously, the first voltage detector 164 detects the load voltage V1 supplied to the first fan driver 170, whereas the second voltage detector 166 detects the load voltage V2 supplied to the second fan driver 172.

In step S1, by an operation in the vehicle compartment performed by an occupant therein, the desired flow rate of air is changed. It will be appreciated that step S1 also is effected in the case that the vehicular air conditioning apparatus 50 is switched from an OFF state to an ON state. In the case that the desired flow rate of air is not changed, the sequence returns to step S1.

In step S2, from the desired flow rate of air, which has been changed, the CPU 162 of the controller 160 calculates a suitable load voltage V1 to be applied to the first blower fan 120, so as to reduce the sum of the consumption power of the first and second blower fans 120, 138 and thereby produce a calculated voltage Vm. Similarly, the controller 160 calculates a suitable load voltage V2 to be applied to the second blower fan 138, thereby producing a calculated voltage Vn.

In step S3, by an instruction from the CPU 162, by applying the calculated voltage Vm from the power source 176 to the first fan driver 170, the rotational velocity n1 of the first blower fan 120 is changed. Similarly, based on an instruction from the CPU 162, by applying the calculated voltage Vn from the power source 176 to the second fan driver 172, the rotational velocity n2 of the second blower fan 138 is changed. As a result, by controlling the load voltages V1, V2, desired flow rates, which have been changed, can be obtained.

As noted previously, the first consumption power W1 is determined by the load voltage V1, whereas the second consumption power W2 is determined by the load voltage V2, and the load voltages V1, V2 are controlled. Thus, driving of the first blower fan 120 and the second blower fan 138 can be controlled. As a result, as shown in FIG. 10, compared to the case where the first fan driver 170 independently drives the first blower fan 120 (refer to the broken line L1 in FIG. 10), and successively the second fan driver 172 independently drives the second blower fan 138 (refer to the broken line L2 in FIG. 10), driving of the first and second blower fans 120, 138 can be controlled so as to reduce the sum of the consumption powers of the first and second blower fans 120, 138, i.e., the sum of the first consumption power W1 and the second consumption power W2 by utilizing the first and second fan drivers 170, 172, whereby the first air and the second air can be supplied efficiently at a desired air flow rate. The characteristic curve L, for example, may be characterized by regions in which the consumption power within respective characteristic curves R1 to R5, which are obtained for a case where the voltage of the first blower fan 120 is fixed and the voltage of the second blower fan 138 is changed, is low. Further, in FIG. 10, the characteristic curve R1 indicates a case in which the voltage of the first blower fan 120 is maintained at 4 V, whereas the voltage of the second blower fan 138 is changed from 4 V to 8 V, the characteristic curve R2 indicates a case in which the voltage of the first blower fan 120 is maintained at 6 V, whereas the voltage of the second blower fan 138 is changed from 4 V to 8 V, the characteristic curve R3 indicates a case in which the voltage of the first blower fan 120 is maintained at 8 V, whereas the voltage of the second blower fan 138 is changed from 6 V to 10 V, the characteristic curve R4 indicates a case in which the voltage of the first blower fan 120 is maintained at 10 V, whereas the voltage of the second blower fan 138 is changed from 8 V to 10 V, and the characteristic curve R5 indicates a case in which the voltage of the first blower fan 120 is maintained at 12 V, whereas the voltage of the second blower fan 138 is changed from 10 V to 13.5 V.

The aforementioned controls may also be performed based on storing an appropriate drive voltage data map beforehand in the memory unit 174, by which drive voltages are applied to the first and second blower motors 121, 141 corresponding to rotation numbers (RPS) for each of the respective blow-out modes.

In the foregoing manner, according to the first embodiment, the vehicular air conditioning apparatus includes the first blower unit 56, the second blower unit 62, passages through which air delivered from the first blower unit 56 and the second blower unit 62 passes, and a casing 52 in which the evaporator 58 that faces toward the passages is disposed, wherein the first blower unit 56 and the second blower unit 62 are connected respectively to the casing 52 by the connection duct 54 and the connection passage 61, and wherein the rotation control device 124a for controlling rotation of the first blower unit 56 and the rotation control device 124b for controlling rotation of the second blower unit 62 are disposed mutually perpendicularly on the outer side of the connection passage having the greater flow passage cross sectional area from among the connection duct 54 and the connection passage 61, i.e., on the connection duct 54. Also, cooling devices 126a, 126b made up from fins for cooling the rotation control devices 124a, 124b, are disposed mutually perpendicularly on inner walls of the connection duct 54. In this case, rotation control devices 124a, 124b are disposed at a location where the flow passage cross sectional area of the connection duct 54 is greatest. Owing thereto, without increasing the fluid resistance of the connection duct 54 and while keeping the fluid resistance inside the connection passage 61 relatively small, adjustment of temperature with good efficiency inside the vehicle compartment can be enabled. Further, since the rotation control devices 124a, 124b are positioned in proximity on the same connection duct 54, ease of maintenance thereon can be enhanced.

As can be appreciated from FIG. 5, the rotation control device 124a and the cooling device 126a are disposed on a first wall surface that forms the connection duct 54, whereas the rotation control device 124b and the cooling device 126b are disposed on a second wall surface perpendicular to the first wall surface. Owing thereto, even though the rotation control devices 124a, 124b are both disposed on the same connection duct 54, since the cooling devices 126a, 126b are both exposed suitably to the air that flows through the interior of the connection duct 54, the rotation control devices 124a, 124b can be cooled efficiently.

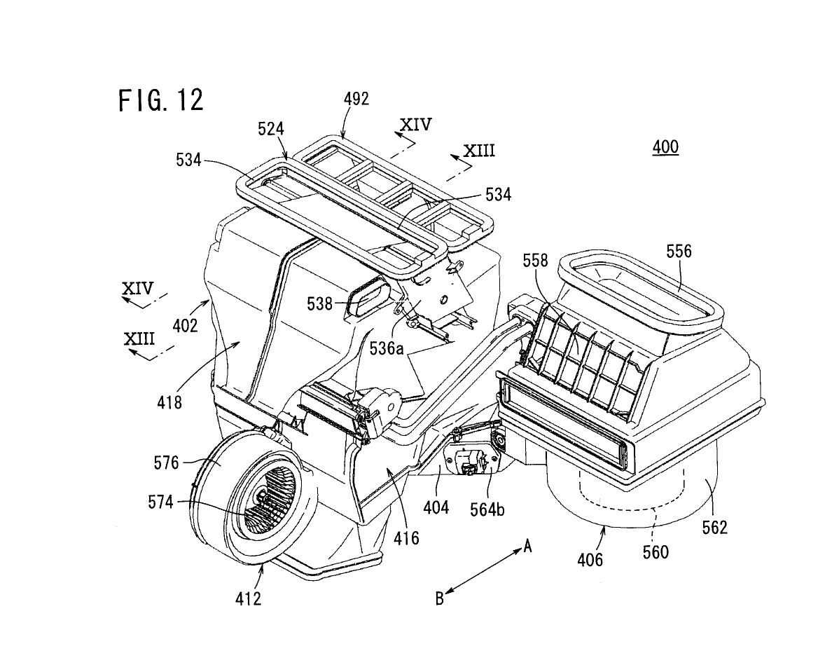

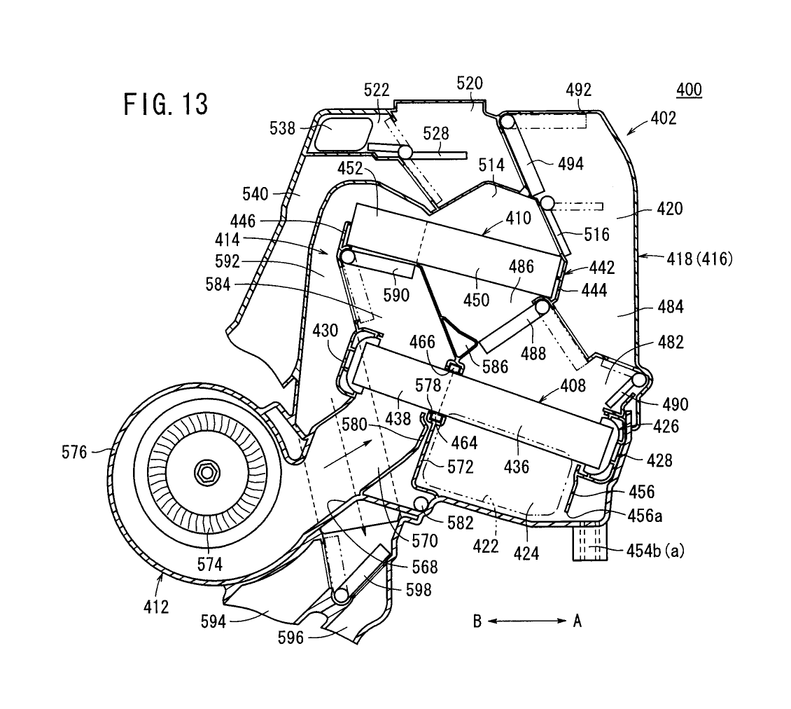

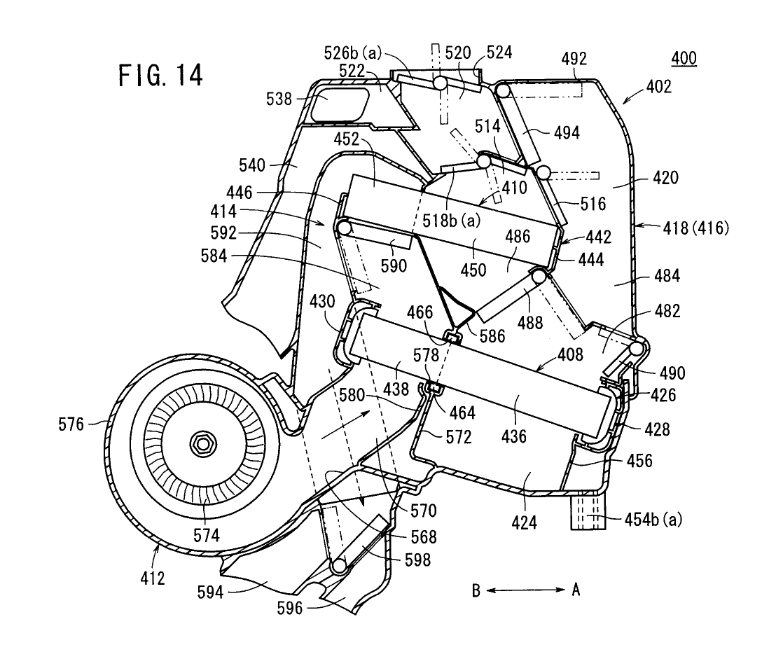

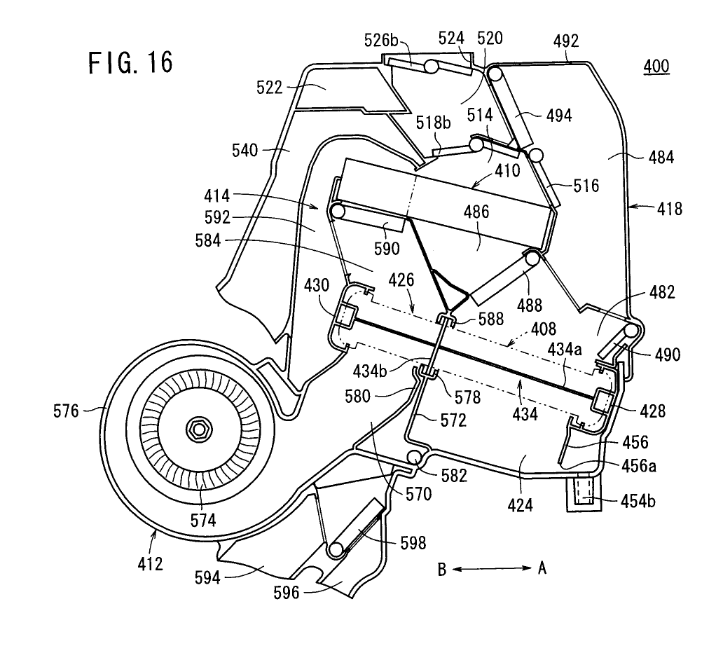

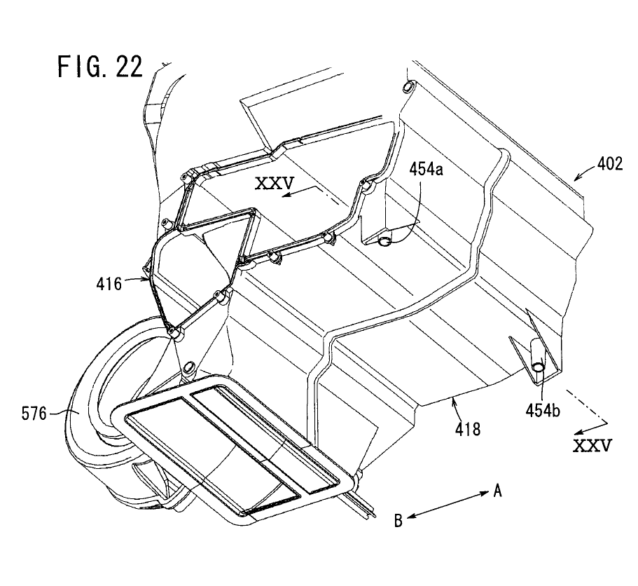

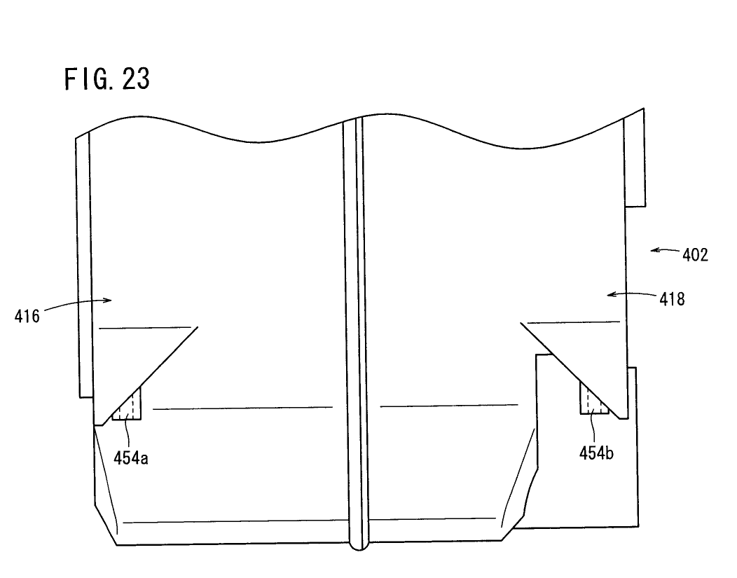

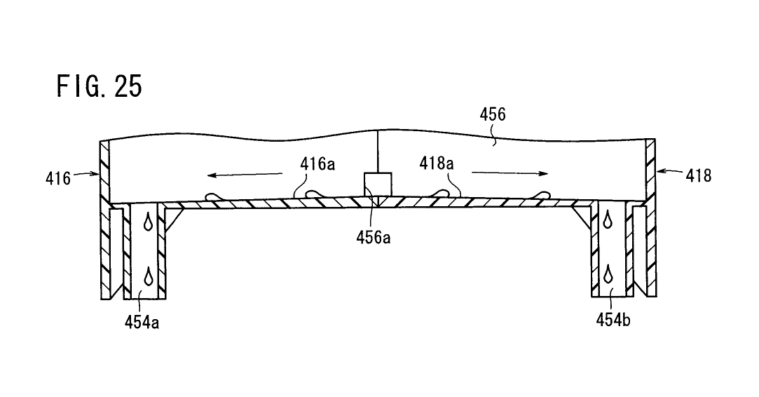

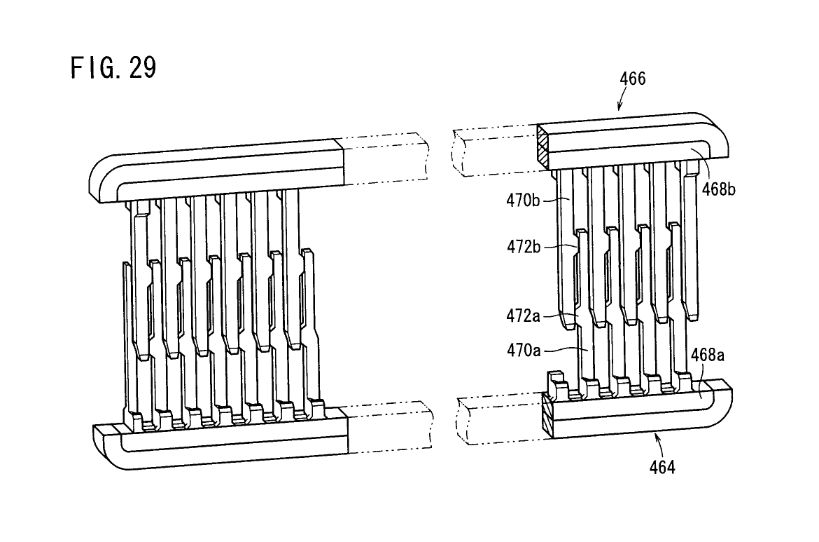

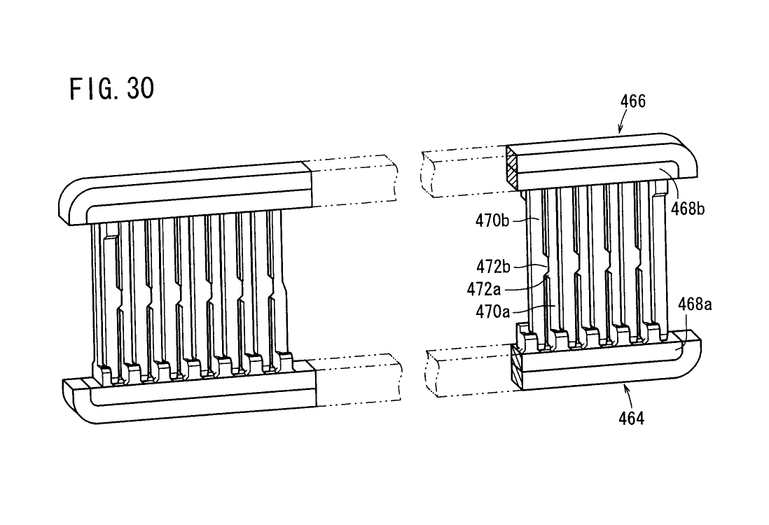

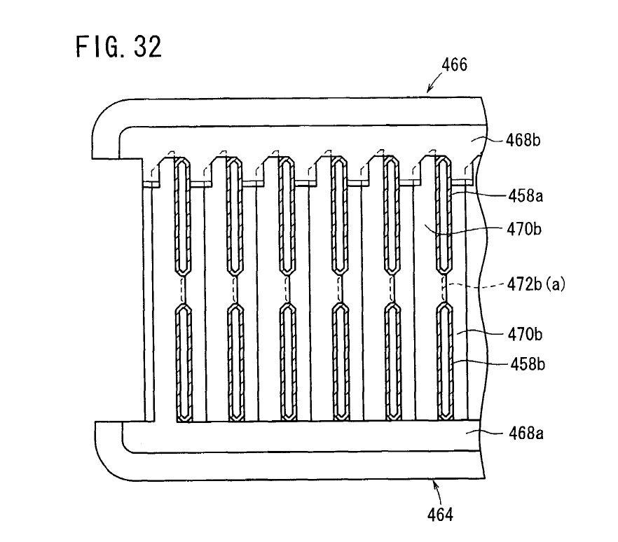

Next, a vehicular air conditioning apparatus 400 according to a second embodiment is shown in FIGS. 12 to 52. FIG. 12 is a perspective view of the vehicular air conditioning apparatus 400. Further, FIG. 13 is a cross sectional view in a central portion (taken along line XIII-XIII in FIG. 12) along the widthwise direction of a vehicular air conditioning apparatus 400, whereas FIG. 14 is a cross sectional view of a region (taken along line XIV-XIV in FIG. 12) somewhat deviated to the side of the second divided casing 418 from the aforementioned central portion.

As shown in FIGS. 12 to 16, the vehicular air conditioning apparatus 400 according to the second embodiment includes a casing 402 constituted by respective air passages, a first blower unit 406 connected through a connection duct 404 to a side portion of the casing 402 for blowing air toward the front seats of the vehicle, an evaporator (heat exchanger) 408 arranged inside the casing 402 for cooling the air, a heater core (heat exchanger) 410 for heating the air, a second blower unit 412 connected to a lower portion of the casing 402 for blowing air toward the middle seats and rear seats of the vehicle, and a damper mechanism 414 for switching the flow of air that flows through and inside each of the respective passages.

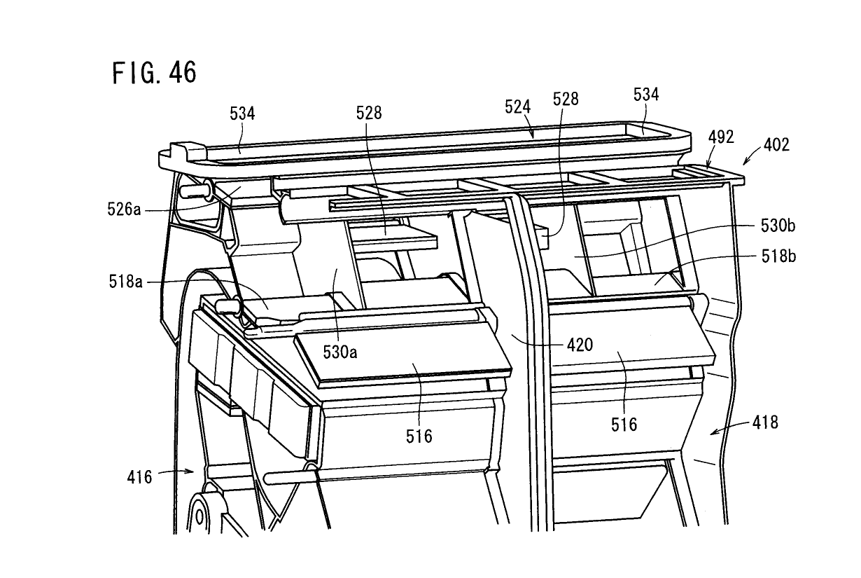

The casing 402 is constituted by first and second divided casings 416, 418 having substantially symmetrical shapes, wherein a center plate 420 (see FIG. 46) is disposed between the first divided casing 416 and the second divided casing 418. The connection duct 404 is connected on a lower side portion of the first divided casing 416, and a first intake port 422 is formed through which air is supplied from the first blower unit 406. The first intake port 422 communicates with a first front passage 424 disposed on an upstream side of the evaporator 408.

As easily understood from FIG. 12, the second blower unit 412 expands outward and is disposed at a joined region of the substantially symmetrical first divided casing 416 and second divided casing 418 that make up the casing 402, more specifically, at a center portion of the casing 402. Further, the second blower unit 412 is positioned inside a non-illustrated center console of the vehicle.

As shown in FIGS. 13 to 16, in the first and second divided casings 416, 418, an evaporator holder 426 is formed for maintaining the evaporator 408, which has a rectangular shape in cross section. The evaporator holder 426 is provided on a lower part of the casing 402 facing the first intake port 422. The evaporator holder 426 includes a first retaining member 428 that holds one end of the evaporator 408 that is disposed on the forward side (in the direction of arrow A) of the casing 402, and a second retaining member 430 that holds another end of the evaporator 408 that is disposed on the rearward side (in the direction of arrow B) of the casing 402. The first and second retaining members 428, 430 are formed with U-shapes in cross section, which open toward one another in mutually facing directions, and extend in the widthwise direction of the casing 402, from an inner wall surface of the first divided casing 416 to an inner wall surface of the second divided casing 418.

Further, because the first retaining member 428 confronts the second retaining member 430 and is disposed downwardly with respect to the second retaining member 430, the evaporator 408, which is retained by the first and second retaining members 428, 430, is disposed such that one end thereof in the forward direction of the vehicle (the direction of arrow A) is inclined downward at a predetermined angle with respect to the other end thereof.

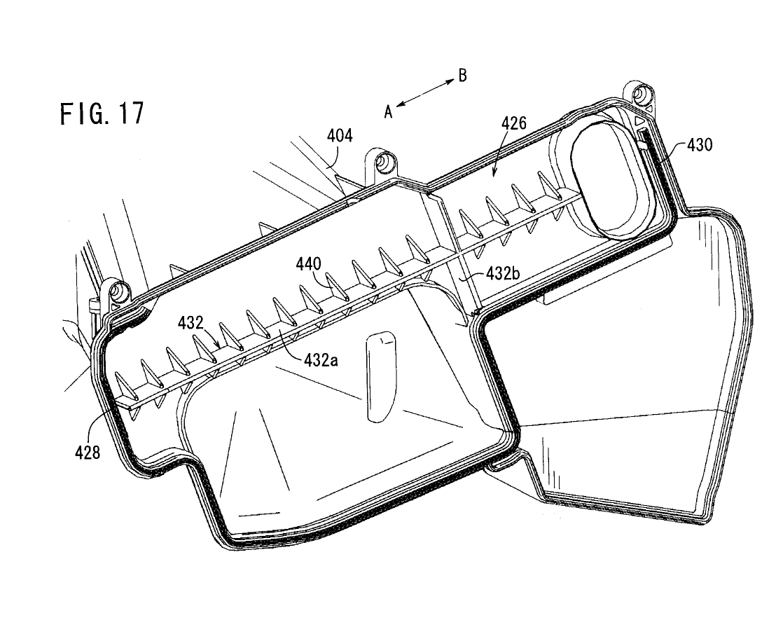

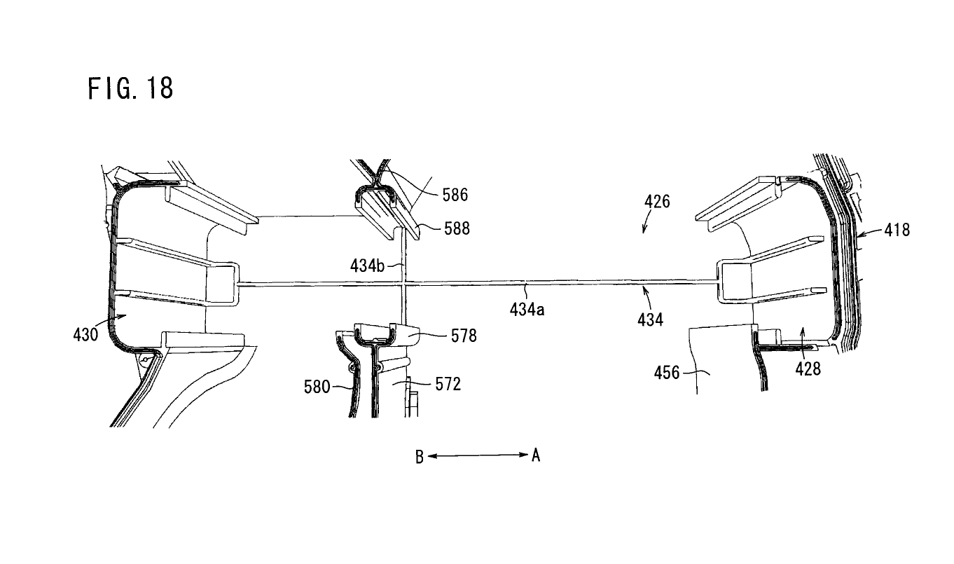

As shown in FIG. 17, a first rib 432, which projects a predetermined height from the inner wall surface at a position between the first retaining member 428 and the second retaining member 430, is formed on the inner wall surface of the first divided casing 416, wherein the first rib 432 abuts against one side surface of the evaporator 408. On the other hand, as shown in FIG. 18, a second rib 434, which projects a predetermined height from the inner wall surface of the second divided casing 418 at a position between the first retaining member 428 and the second retaining member 430, is formed on the inner wall surface thereof, confronting the first rib 432, wherein the second rib 434 abuts against the other side surface of the evaporator 408.

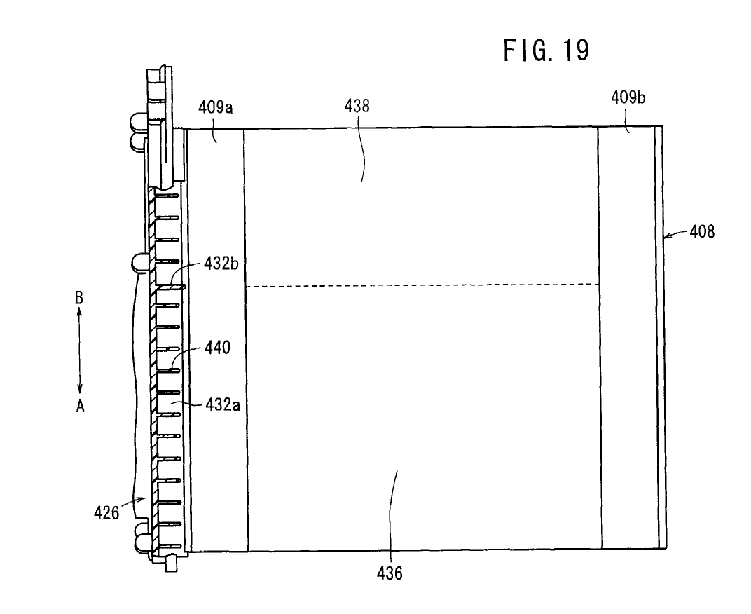

The first and second ribs 432, 434 are formed respectively with cross-like shapes, such that horizontal ribs 432a, 434a thereof, which extend from the first retaining member 428 to the second retaining member 430, abut roughly in the center of the evaporator 408 to divide the evaporator 408 in half in the thickness direction thereof. On the other hand, vertical ribs 432b, 434b, which are perpendicular to the horizontal ribs 432a, 434a, abut against a boundary portion in the evaporator 408 of a first cooling section 436 through which air supplied from the first blower unit 406 passes, and a second cooling section 438 through which air supplied from the second blower unit 412 passes (refer to FIG. 19). Further, compared to the second rib 434, the first rib 432 is set to have a greater height from the inner wall surface of the first divided casing 416, and the horizontal rib 432a and vertical rib 432b are formed perpendicularly with respect to the inner wall surface.

More specifically, by abutment of the horizontal ribs 432a, 434a of the first and second ribs 432, 434 against side surfaces of the evaporator 408, air is prevented from flowing to the downstream side between inner wall surfaces of the first and second divided casings 416, 418 and the evaporator 408. On the other hand, by abutment of the vertical ribs 432b, 434b of the first and second ribs 432, 434 against the boundary portion of the first cooling section 436 and the second cooling section 438, air supplied from the first blower unit 406 is prevented from flowing through the side of the second cooling section 438 at times when the second blower unit 412 is halted, and conversely, air supplied from the second blower unit 412 is prevented from flowing through the side of the first cooling section 436 at times when the first blower unit 406 is halted.

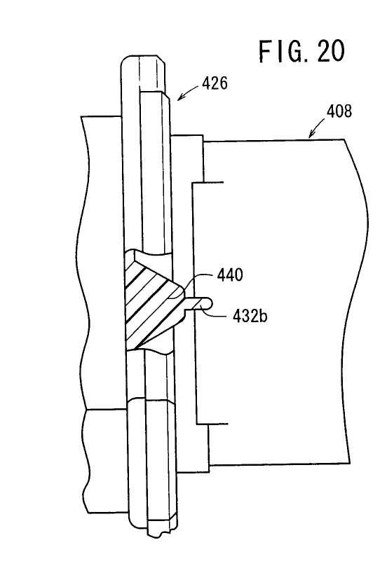

Furthermore, on the inner wall surface of the first divided casing 416, a plurality of reinforcement ribs 440 are formed substantially parallel with the vertical ribs 432b. The reinforcement ribs 440 are disposed with respect to upper and lower surface sides of the horizontal rib 432a, and are formed with substantially triangular shapes in cross section, which taper in a direction away from the inner wall surface (see FIGS. 17 and 20).

Further, as shown in FIGS. 13 and 14, on the first and second divided casings 416, 418, a heater holder 442 is formed for maintaining a heater, which has a rectangular shape in cross section. The heater holder 442 is provided upwardly of the evaporator holder 426. The heater holder 442 includes a first retaining member 444 that holds one end of the heater core 410 that is disposed on the forward side (in the direction of arrow A) of the casing 402, and a second retaining member 446 that holds another end of the heater core 410 that is disposed on the rearward side (in the direction of arrow B) of the casing 402. The first retaining member 444 is formed to cover one end portion of the heater core 410, whereas the second retaining member 446 is formed to cover a lower half part only of the other end of the heater core 410. The first and second retaining members 444, 446 extend along the widthwise direction of the casing 402, from an inner wall surface of the first divided casing 416 to an inner wall surface of the second divided casing 418.

Further, because the first retaining member 444 confronts the second retaining member 446 and is disposed downwardly with respect to the second retaining member 446, the heater core 410, which is retained by the first and second retaining members 444, 446, is disposed such that one end thereof in the forward direction of the vehicle (the direction of arrow A) is inclined downward at a predetermined angle with respect to the other end thereof.

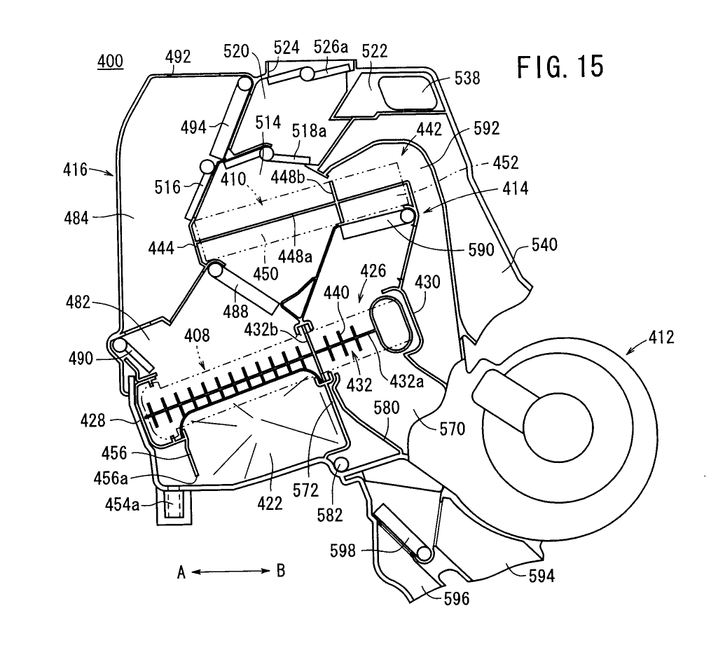

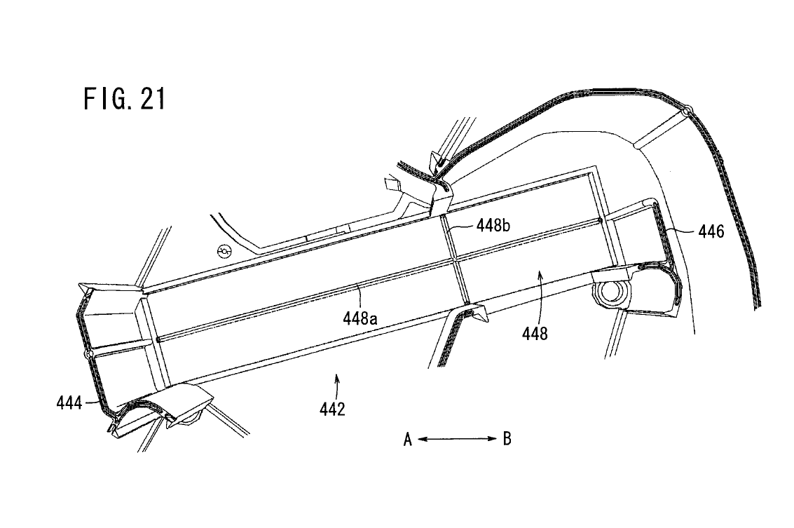

Furthermore, as shown in FIG. 21, a rib 448, which projects a predetermined height from the inner wall surface at a position between the first retaining member 444 and the second retaining member 446, is formed on the inner wall surface of the first divided casing 416, such that the rib 448 abuts against one side surface of the heater core 410. The rib 448 is formed with a cross-like shape, such that a horizontal rib 448a thereof, which extends from the first retaining member 444 to the second retaining member 446, abuts roughly in the center of the heater core 410 to divide the heater core 410 in half in the thickness direction thereof. On the other hand, a vertical rib 448b, which is perpendicular to the horizontal rib 448a, abuts against a boundary portion in the heater core 410 of a first heating section 450 through which air supplied from the first blower unit 406 passes, and a second heating section 452 through which air supplied from the second blower unit 412 passes (refer to FIG. 15). Further, in the second divided casing 418, a region thereof opens in a direction facing toward the heater core 410.

More specifically, by abutment of the horizontal rib 448a of the rib 448 against a side surface of the heater core 410, air is prevented from flowing to the downstream side between the inner wall surface of the first divided casing 416 and the heater core 410. At the same time, by abutment of the vertical rib 448b against the boundary portion of the first heating section 450 and the second heating section 452, air supplied from the first blower unit 406 is prevented from flowing through the side of the second heating section 452 at times when the second blower unit 412 is halted, and conversely, air supplied from the second blower unit 412 is prevented from flowing through the side of the first heating section 450 at times when the first blower unit 406 is halted.

On the other hand, as shown in FIG. 13 and FIGS. 22 to 25, the bottom portion of the casing 402 is formed such that the front side thereof (in the direction of arrow A) is lowest, with a pair of first drain ports 454a, 454b being disposed at this location. The first drain ports 454a, 454b are formed in tubular shapes and extend in vertically downward directions from frontal bottom surfaces 416a, 418a on a frontward side (the direction of arrow A) from a first guide panel 456 in the first and second divided casings 416, 418. Further, the first drain ports 454a, 454b are disposed in the vicinity of opposite side portions, mutually separated in the widthwise direction of the casing 402, and communicate from the interior of the casing 402 to the exterior thereof.

Further, as shown in FIGS. 13 to 16, on the bottom portion of the casing 402, the first guide panel 456 is formed, which faces toward the first front passage 424 on a forward side (in the direction of arrow A) adjacent to the first drain ports 454a, 454b. The first guide panel 456 is arranged in an upstanding manner along the extending direction of the first front passage 424. An upper end part thereof extends to the vicinity of the lower surface of the evaporator 408, and is bent in a direction (the direction of arrow B) separating from the evaporator holder 426 that retains the evaporator 408.

Owing thereto, in the evaporator 408, for example, although water condensation is generated when air passing through the interior of the evaporator 408 is cooled, because one end side thereof is disposed to be inclined downwardly at a predetermined angle, moisture that is generated inside the evaporator 408 can be moved to one end side, i.e., the front side of the vehicle (in the direction of arrow A), along the lower surface of the evaporator 408.

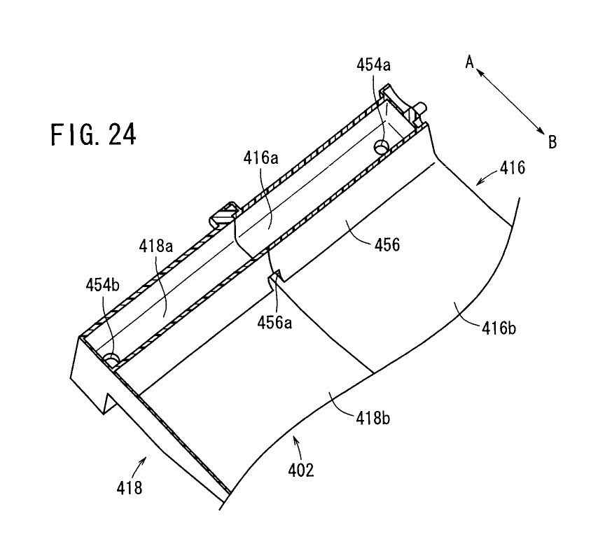

Further, when the moisture moves along the lower surface of the evaporator 408, it comes into contact with the upper end of the first guide panel 456 and is guided downwardly along the first guide panel 456, and falls onto rearward bottom surfaces 416b, 418b (see FIG. 24) that form a bottom surface between the first guide panel 456 and a first dividing wall 572 in the first and second divided casings 416, 418. In addition, the fallen moisture is guided to the frontal bottom surfaces 416a, 418a of the first and second divided casings 416, 418 through a hole 456a disposed at a bottom part of the first guide panel 456 (see FIG. 24). Since the first drain ports 454a, 454b are disposed at positions where inclined surfaces of the frontal bottom surfaces 416a, 418a, which gradually decline toward opposite side portions of the casing 402, terminate (see FIG. 24), moisture that is guided toward the frontal bottom surfaces 416a, 418a is guided suitably to the first drain ports 454a, 454b and is discharged to the exterior.

In this case, although the rearward bottom surfaces 416b, 418b are inclined downwardly toward the hole 456a such that fallen moisture is guided suitably to the hole 456a, the inclination of the rearward bottom surfaces 416b, 418b is not strictly limited to this form.

Further, in this manner, since the first drain ports 454a, 454b are disposed at positions where inclined surfaces on the frontal bottom surfaces 416a, 418a, which gradually decline toward opposite side portions of the casing 402, terminate, compared to a structure in which the frontal bottom surfaces 416a, 418a are inclined in one direction in the widthwise direction of the vehicle, the size in the vertical direction of the casing 402 can be reduced as much as possible. Also, in FIG. 24, although only one hole 456a is provided, the invention is not necessarily limited to this feature, and two or more of such holes may also be provided.

Owing thereto, accumulation of moisture discharged from the evaporator 408 within the first front passage 424, thus becoming a cause of foul odors, and further, leakage of moisture into the interior of the vehicle compartment, are prevented.

Moreover, the first drain ports 454a, 454b are not limited to being provided in a pair, and three or more drain ports may also be provided.

Further, even in the case that the casing 402 is mounted on the floor or the like before the vehicular air conditioning apparatus 400 is installed in the vehicle, since the pair of first drain ports 454a, 454b which project from the bottom of the casing 402 are disposed in a pair, the first drain ports 454a, 454b can be mounted stably as leg portions. Owing thereto, when components such as the first and second blower units 406, 412 are assembled onto the casing 402, such assembly can be performed easily without requiring a specialized jig or the like.

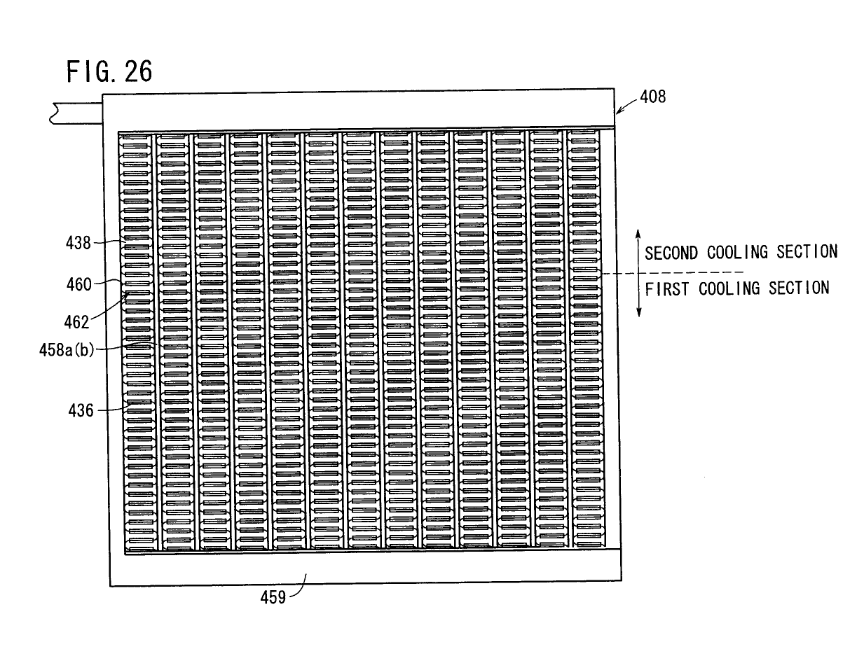

As shown in FIG. 26, in the evaporator 408, for example, tubes 458a, 458b are formed from thin plates of aluminum or the like, and fins 460, which are folded in a serpentine-like undulating shape, are disposed respectively between the stacked tubes 458a, 458b. On the fins 460, a plurality of louvers 462 are formed, which are cut out so as to be inclined at predetermined angles with respect to the planar surface of the fins 460. By causing a coolant medium to flow through the interior of the tubes 458a, 458b, air that passes through the louvers 462 and flows between the fins 460 is cooled by the coolant medium and is supplied to the downstream side as chilled air. At the evaporator 408, the paired tubes 458a, 458b are arrayed in parallel and arranged in two layers in the thickness direction of the evaporator 408.

Further, the evaporator 408 includes the first cooling section 436, which cools air supplied from the first blower unit 406, and the second cooling section 438, which cools air supplied from the second blower unit 412. Additionally, the first cooling section 436 is arranged in the forward direction (the direction of arrow A) of the casing 402, whereas the second cooling section 438 is arranged in the rearward direction (the direction of arrow B) of the casing 402.

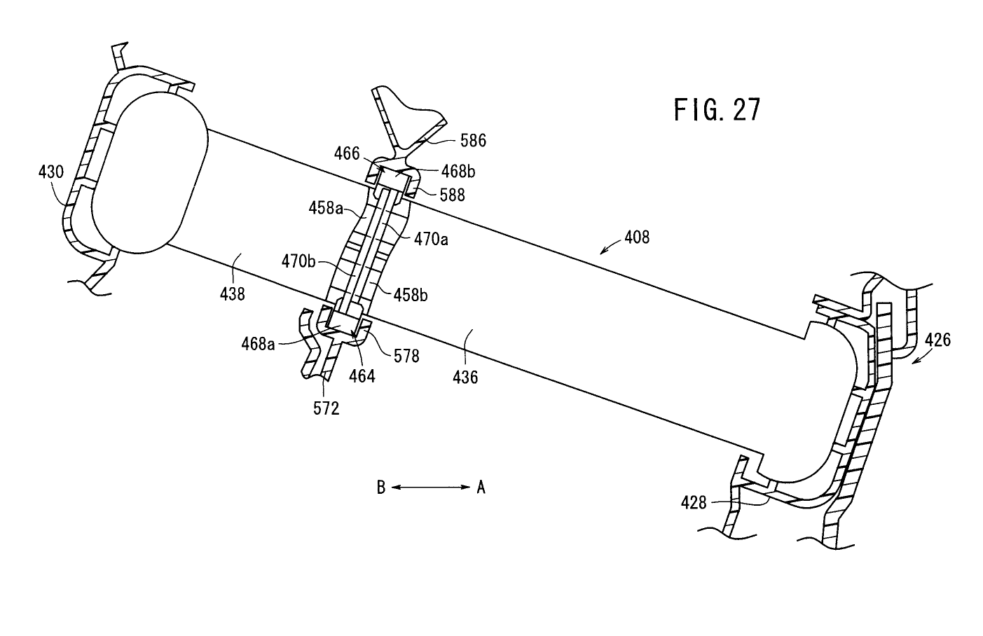

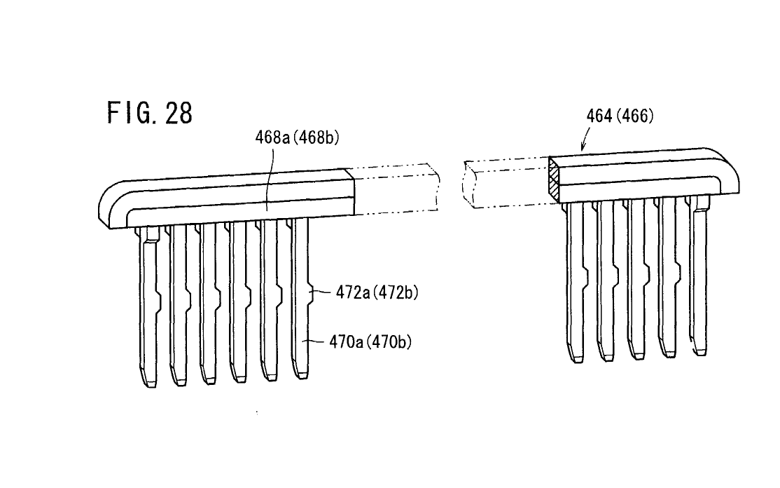

At the boundary region between the first cooling section 436 and the second cooling section 438, as shown in FIG. 27, a pair of first and second partitioning members 464, 466 are installed for blocking communication of air between the first cooling section 436 and the second cooling section 438. As shown in FIGS. 28 to 30, the first and second partitioning members 464, 466 are formed from a resin material, for example, and are equipped with straightly formed base portions 468a, 468b, and a plurality of sealing portions 470a, 470b, which project at a predetermined length from the lower surface of the base portions 468a, 468b. Also, projections 472a, 472b are formed thereon, which project in a direction perpendicular to the lengthwise direction, centrally along the lengthwise direction of the sealing portions 470a, 470b. The sealing portions 470a, 470b are formed with the same length, and are disposed so as to be separated mutually at equal intervals along the base portions 468a, 468b. Further, the projections 472a, 472b project in the same directions with respect to the sealing portions 470a, 470b.

Additionally, as shown in FIG. 27, the first partitioning member 464 is mounted on a lower surface side of the evaporator 408 on the upstream side thereof, such that the sealing portions 470a thereof are inserted between the stacked tubes 458a, 458b in the evaporator 408, and the base portion 468a abuts against the lower surface. On the other hand, the second partitioning member 466 is mounted on an upper surface side of the evaporator 408 on the downstream side thereof, such that the sealing portions 470b thereof are inserted on an opposite side from the first partitioning member 464 between the tubes 458a, 458b, and the base portion 468b abuts against the upper surface.

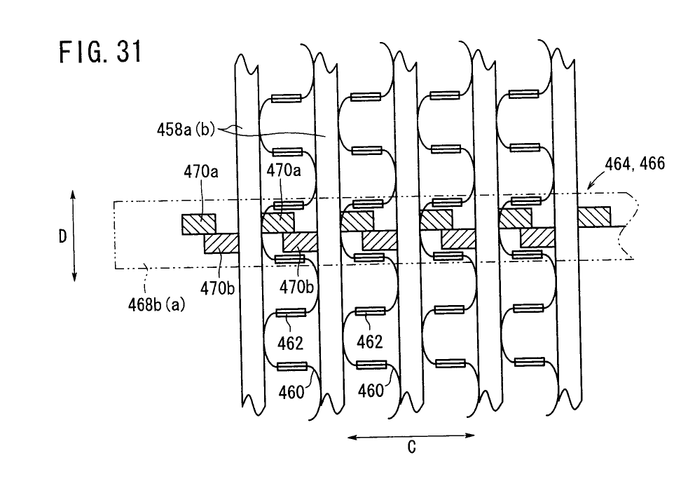

At this time, as shown in FIG. 31, the sealing portions 470a of the first partitioning member 464 and the sealing portions 470b of the second partitioning member 466 are offset from each other along the direction of extension (the direction of arrow C) of the base portions 468a, 468b, and further, overlap in the direction of extension of the tubes 458a, 458b. Owing to the two sealing portions 470a, 470b, which are mutually overlapped in this manner, intervals between adjacent tubes 458a, 458b in the same layer are sealed respectively. Next, projections 472a of the first partitioning member 464 and the projections 472b of the second partitioning member 466 are inserted between the adjacent tubes 458a and the tubes 458b, while the first partitioning member 464 and the second partitioning member 466 are slid respectively along the direction of extension (the direction of arrow C) of the base portions 468a, 468b. Consequently, the projections 472a of the first partitioning member 464 and the projections 472b of the second partitioning member 466 overlap in the direction of extension of the tubes 458a, 458b, and gaps occurring between the tubes 458a disposed on the upper surface side and the tubes 458b disposed on the lower surface side are sealed (see FIG. 31).

Consequently, since the flow of air between the tubes 458a, 458b, which are disposed in two layers, is blocked by the first and second partitioning members 464, 466 installed between the first cooling section 436 and the second cooling section 438, flow of air between the first cooling section 436 and the second cooling section 438 is prevented (see FIG. 31).

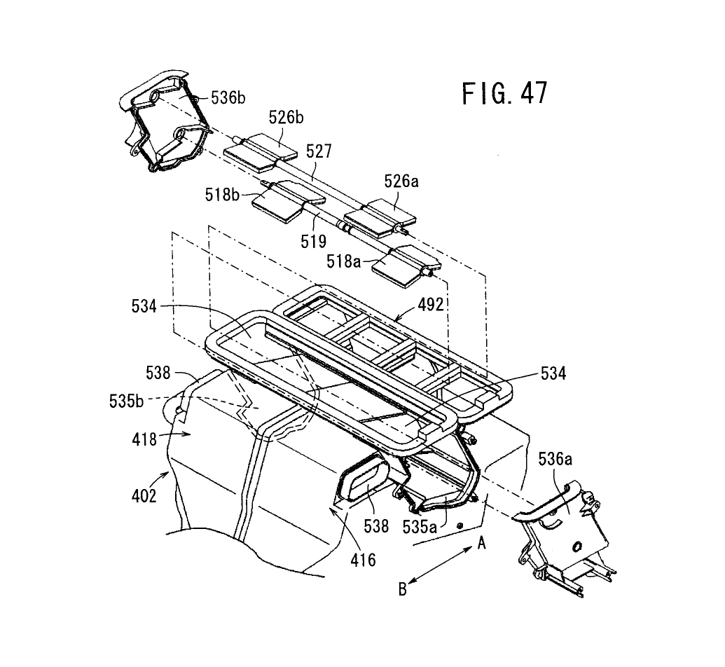

Moreover, in a condition of being installed on the evaporator 408, the base portions 468a, 468b of the first and second partitioning members 464, 466 are retained respectively in base holders 578, 588, which are formed in the casing 402 (see FIG. 47).

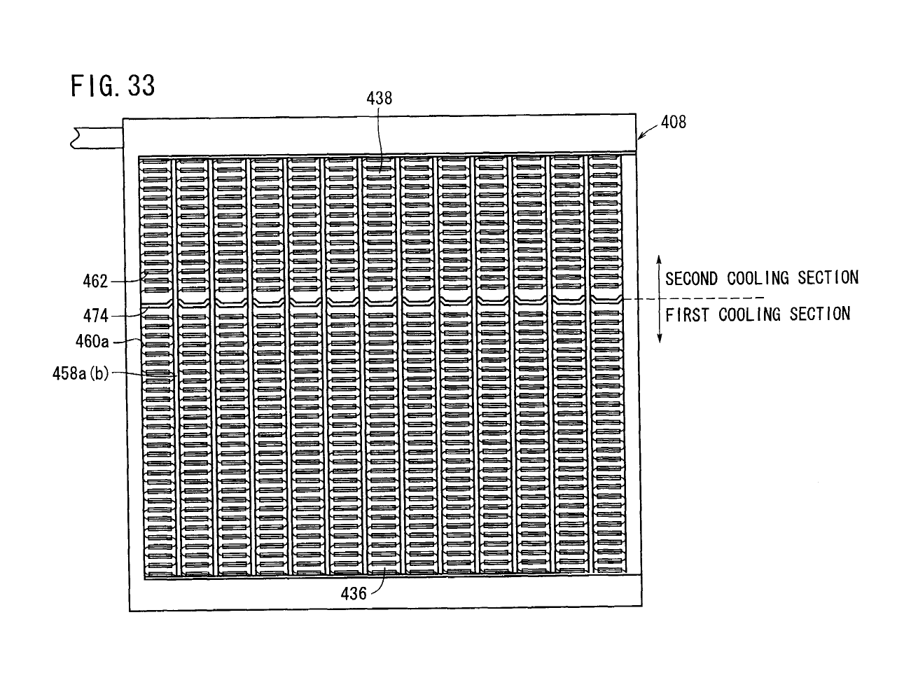

Further, the means for blocking communication of air between the first cooling section 436 and the second cooling section 438 in the evaporator 408 is not limited to the aforementioned first and second partitioning members 464, 466. For example, as shown in FIG. 33, in place of the aforementioned first and second partitioning members 464, 466, a plate-shaped partition plate 474 may also be disposed at the boundary region between the first cooling section 436 and the second cooling section 438.

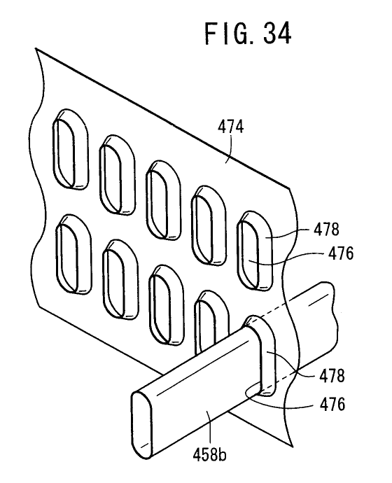

The partition plate 474, as shown in FIGS. 33 and 34, includes a plurality of insertion holes 476 therein through which the tubes 458a, 458b are inserted. Pressing members 478, which are inclined at predetermined angles from the partition plate 474 about centers of the insertion holes 476, are formed in openings of the insertion holes 476. The pressing members 478 are substantially chevron-shaped in cross section about the center of the insertion holes 476, and are tiltable with a certain resiliency in a radial direction of the insertion holes about a fulcrum point defined by an adjoining region with the partition plate 474.

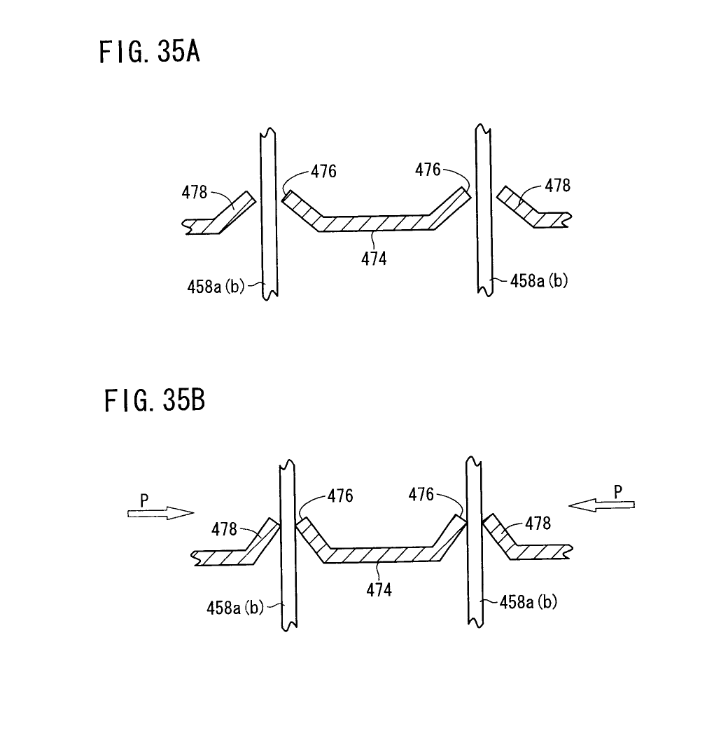

In addition, for example, a cut line or seam is disposed in fins 460a forming a boundary between the first cooling section 436 and the second cooling section 438. After the partition plate 474 is inserted between the fins 460a, the tubes 458a, 458b are inserted respectively through the insertion holes 476 of the partition plate 474 (see FIG. 35A). Then, in such a provisionally assembled state, as shown in FIG. 35B, a pressing force P is applied respectively from the right and left in a direction to approach mutually toward the plural tubes 458a, 458b, and while heat is applied thereto, welding (e.g., using solder) is carried out, whereby the tubes 458a, 458b, the fins 460a, and the partition plate 474 are mutually bonded together to manufacture the evaporator 408 (see FIG. 33).

At this time, the pressing members 478 of the partition plate 474 contact the side surfaces of the tubes 458a, 458b due to the pressing force P, and further, because the tubes 458a, 458b are retained by the resilient force thereof, a state in which the partition plate 474 and the tubes 458a, 458b are mutually positioned can be realized. By performing welding in such a positioned state, for example, generation of thermal shrinkage after welding and the occurrence of gaps between the partition plate 474 and the tubes 458a, 458b is prevented.

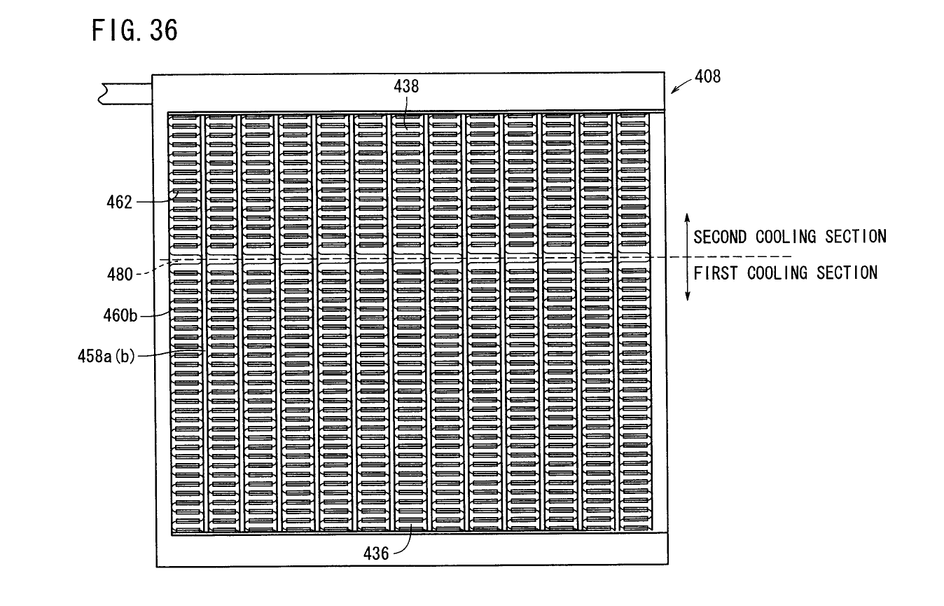

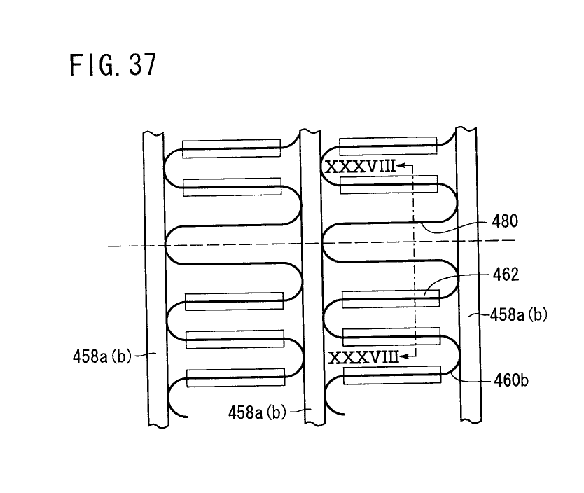

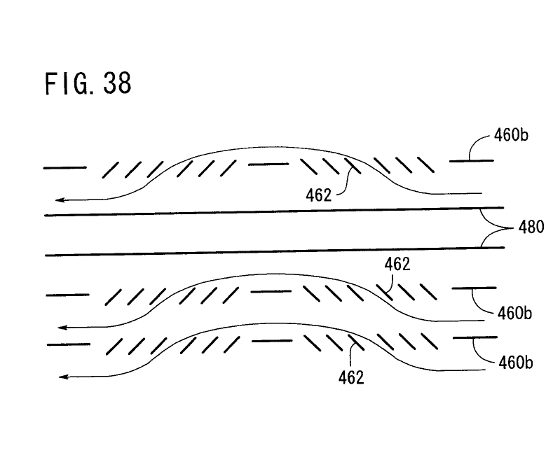

Furthermore, in place of the above-discussed first and second partitioning members 464, 466 or the partition plate 474, for example, as shown in FIGS. 36 and 37, louverless portions 480, without the louvers 462 being provided thereon, may also be formed in fins 460b, at a boundary region located between the first cooling section 436 and the second cooling section 438. As a result thereof, as shown in FIG. 38, by providing the louverless portions 480 at an intermediate location of the fins 460b that have the louvers 462 thereon, flow of air through the louvers 462 is interrupted, and flowing of air between the first cooling section 436 and the second cooling section 438 can be prevented.

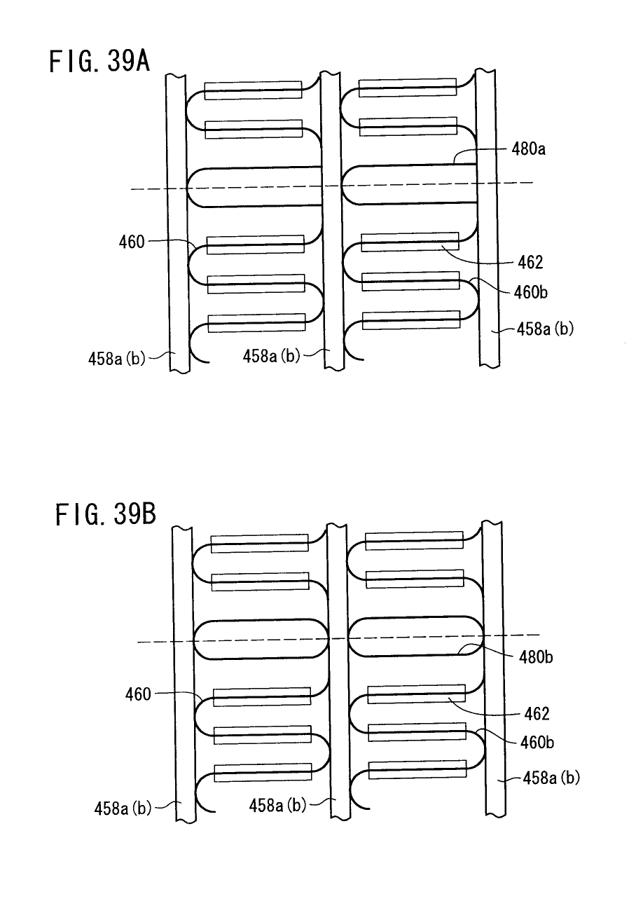

Further, the aforementioned louverless portions 480 are not limited to a case of being provided as a unitary body with the fins 460b having the louvers 462. For example, as shown in FIG. 39A, cutouts may be provided in the fins 460b having the louvers 462 thereon, wherein U-shaped louverless portions 480a are then inserted through the cutouts and joined therein. Similarly, as shown in FIG. 39B, louverless portions 480b having elliptical shapes in cross section may be inserted therein and joined, so as to prevent air from flowing between the first cooling section 436 and the second cooling section 438.

On the other hand, as shown in FIG. 13, on a downstream side of the evaporator 408, a second front passage 482 is formed, through which air having passed through the first cooling section 436 is supplied. Upwardly of the second front passage 482, a third front passage 484 and a fourth front passage 486 are formed in a branching or bifurcated manner. Further, a first air mixing damper 488 is rotatably disposed so as to face toward the branching portion of the third front passage 484 and the fourth front passage 486.

By rotation of the first air mixing damper 488, the blowing condition and blowing rate of the cooled air that has passed through the evaporator 408 into the third front passage 484 and the fourth front passage 486 is adjusted. The third front passage 484 is arranged in the forward direction (the direction of arrow A), whereas the fourth front passage 486 is arranged in the rearward direction (the direction of arrow B), of the casing 402. The heater core 410 is disposed on a downstream side of the fourth front passage 486.

Upstream of the third front passage 484, a cooling vent damper 490 is disposed in a downward direction facing the second front passage 482, for switching a communication state between the second front passage 482 and the third front passage 484. More specifically, because the cooling vent damper 490 is arranged in the vicinity of the evaporator 408, the cooling vent damper 490 is disposed such that, under a switching action thereof, chilled air cooled by the evaporator 408 is supplied directly into the third front passage 484.

Further, the third front passage 484 extends upwardly, and a first vent blow-out port 492 opens at an upper portion on the downstream side thereof, where a vent damper 494 is rotatably disposed. The vent damper 494 switches a blowing state of air that flows through the third front passage 484, when the air is blown to the first vent blow-out port 492 and a later described sixth front passage 520, and also is capable of adjusting the blowing rate thereof.

The heater core 410 is arranged to straddle between the first divided casing 416 and the second divided casing 418, and is disposed such that one end thereof in the forward direction of the vehicle (the direction of arrow A) is inclined downward at a predetermined angle with respect to the other end thereof in the rearward direction (the direction of arrow B) of the vehicle. The heater core 410 includes the first heating section 450 that heats air supplied from the first blower unit 406, and the second heating section 452 that heats air supplied from the second blower unit 412, wherein the first heating section 450 is arranged on the forward side of the casing 402.

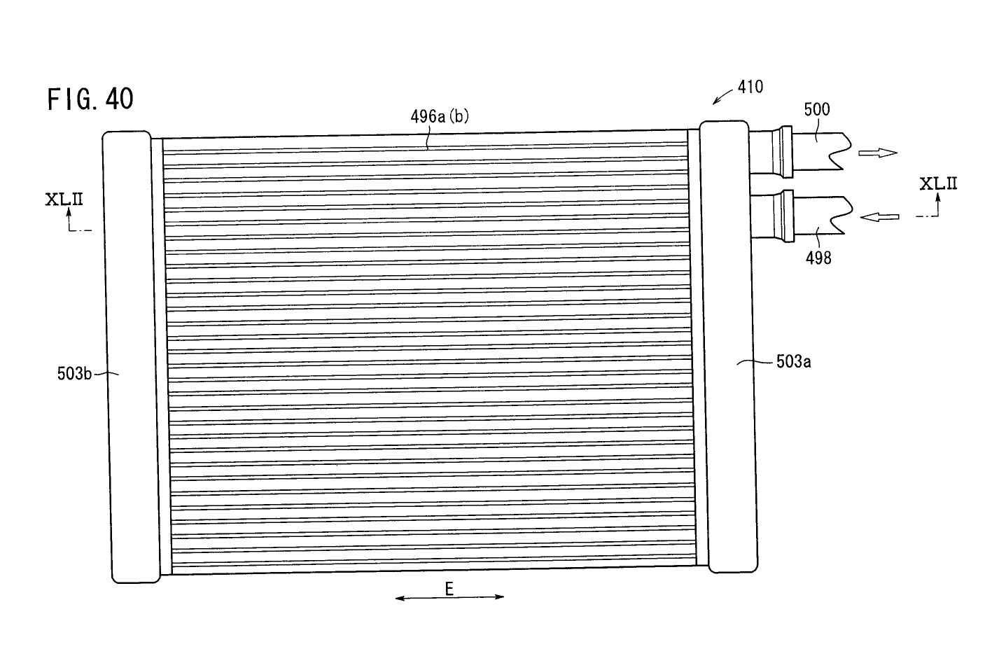

As shown in FIG. 40, in the heater core 410, tubes 496a, 496b are formed from thin plates of aluminum or the like, and fins (not shown), which are folded in a serpentine-like undulating shape, are disposed respectively between the stacked tubes 496a, 496b. On the fins, a plurality of louvers are formed, which are cut out so as to be inclined at predetermined angles with respect to planar surfaces of the fins. By causing heated water to flow through the interior of the tubes 496a, 496b, air that passes through the louvers and flows between the fins is heated by the heated water and is supplied to the downstream side as heated air. At the heater core 410, the tubes 496a, 496b are arrayed in parallel and arranged in two layers in the thickness direction of the heater core 410.

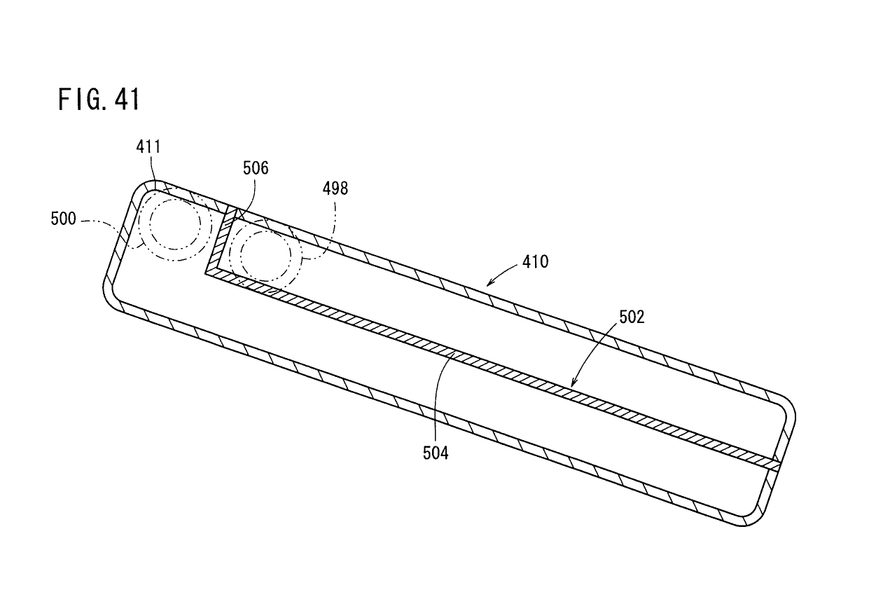

On both ends of the tubes 496a, 496b, respective hollow tank portions 503a, 503b are connected, which retain the heated water that flows inside the tubes 496a, 496b. In addition, as shown in FIGS. 40 and 41, on one of the tank portions 503a on a side surface of the heater core 410, a supply conduit 498 through which heated water is supplied from the exterior, and a discharge conduit 500 through which heated water having circulated through the interior of the heater core 410 is discharged, are connected respectively. The discharge conduit 500 is arranged in the vicinity of a corner portion in a rear upward direction of the casing 402, whereas the supply conduit 498 is arranged in parallel adjacent to the discharge conduit 500.

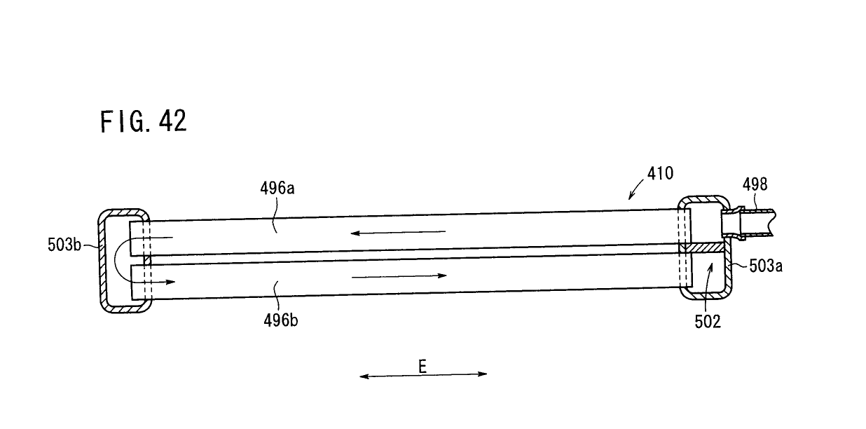

On the other hand, in the interior of the tank portion 503a, a baffle plate 502 is disposed, which is substantially L-shaped in cross section. The baffle plate 502 extends at a predetermined width in an extending direction (the direction of arrow E) of the supply conduit 498 and the discharge conduit 500, and the baffle plate 502 is arranged between one of the tubes 496a and the other of the tubes 496b. Additionally, as shown in FIG. 42, the pair of tubes 496a, 496b are separated inside the tank portion 503a by the baffle plate 502.

The baffle plate 502, as shown in FIG. 41, is made up from a planar portion 504 arranged centrally in the thickness direction of the heater core 410 and a bent portion 506, which is bent at a right angle at one end of the planar portion 504. The bent portion 506 is disposed between the discharge conduit 500 and the supply conduit 498.

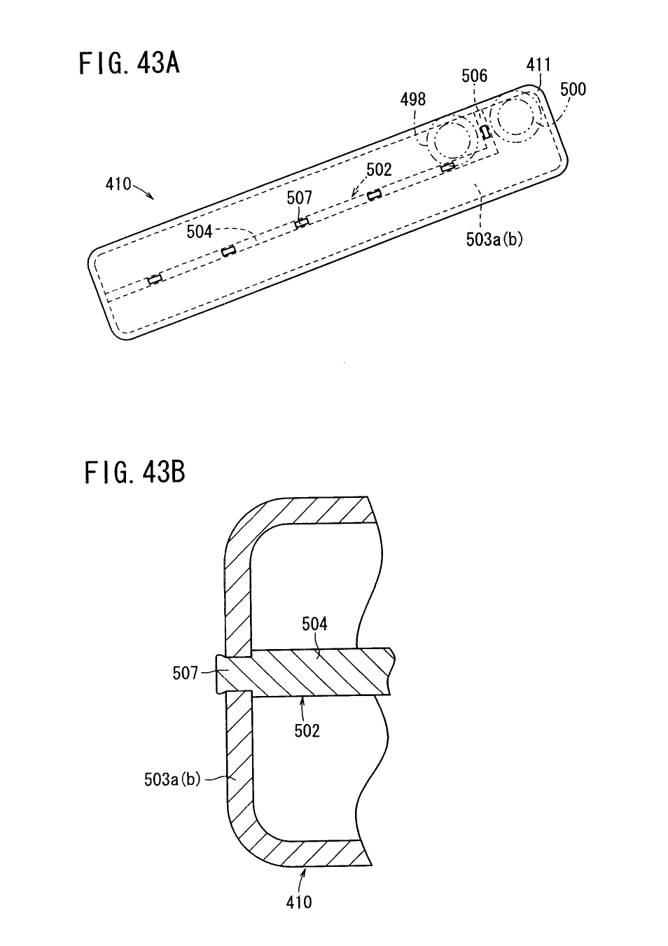

Further, on the baffle plate 502, a plurality of caulking projections 507 (see FIG. 43A) are disposed respectively on both ends thereof along the longitudinal direction (the direction of arrow E) of the heater core 410. After such caulking projections 507 have been inserted through holes formed in a side surface of the tank portion 503a to project outwardly therefrom, the projecting regions thereof are pressed and crushed by a non-illustrated jig or the like (see FIG. 43B). Moreover, the caulking projections 507 are formed with rectangular shapes in cross section and are disposed while being mutually separated at predetermined distances on side surfaces of the planar portion 504 and the bent portion 506. Together therewith, holes facing the planar portion 504 are disposed centrally in the thickness direction on the tank portion 503a, and holes facing the bent portion 506 are disposed at positions between the supply conduit 498 and the discharge conduit 500 (see FIG. 43A).

As a result thereof, the baffle plate 502 is affixed securely with respect to the tank portion 503a disposed on the end of the heater core 410.

In addition, heated water supplied from the supply conduit 498 is supplied, via the one tank portion 503a, to one of the tubes 496a, which is disposed on the upper side. Then, after the heated water has flowed through the tube 496a to the other end side of the heater core 410, the heated water reverses direction inside the tank portion 503b disposed at the other end of the heater core 410, passes through the other tube 496b disposed on the lower side, and flows along the lower surface side of the baffle plate 502 back to the one end side of the heater core 410, whereupon the heated water is discharged from the discharge conduit 500.

At this time, since the discharge conduit 500 is connected at an upper corner portion 411 (in the rearward direction) of the heater core 410, which is inclined at a predetermined angle, even in the case that entrapped or retained air is generated inside the heater core 410, the air can be reliably discharged to the exterior through the discharge conduit 500, which is connected at the upper corner portion 411 where such retained air is generated. Stated otherwise, the discharge conduit 500 is connected at an uppermost position in the heater core 410, with the heater core 410 being disposed at a predetermined angle of inclination inside the casing 402.

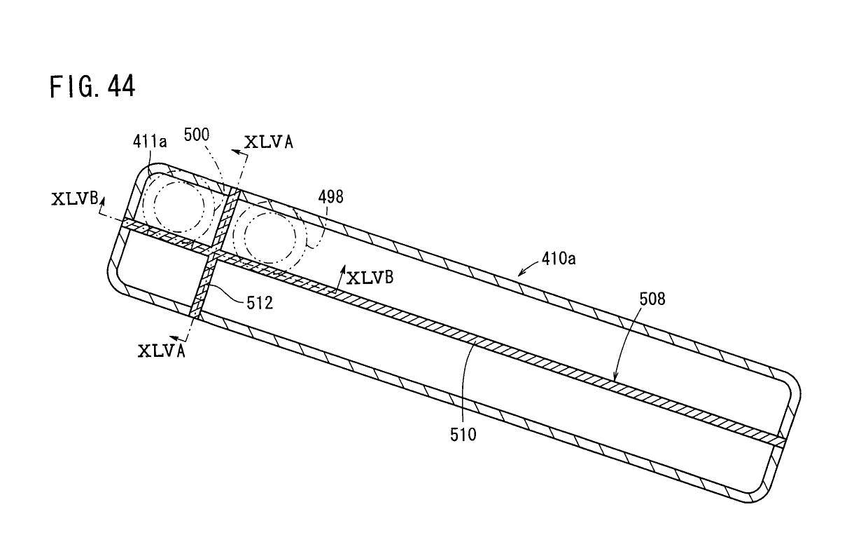

Further, the baffle plate 502, which is disposed inside the heater core 410, is not limited to having an L-shape in cross section, as described above. For example, as shown in FIG. 44, a baffle plate 508 having a cross-like shape in cross section in a heater core 410a may also be used.

As shown in FIG. 44, the baffle plate 508 includes a planar portion 510 and a vertical portion 512 that intersects at a right angle with respect to the planar portion 510. The planar portion 510 is arranged centrally in the thickness direction of the heater core 410a, and the vertical portion 512 is arranged between the discharge conduit 500 and the supply conduit 498.

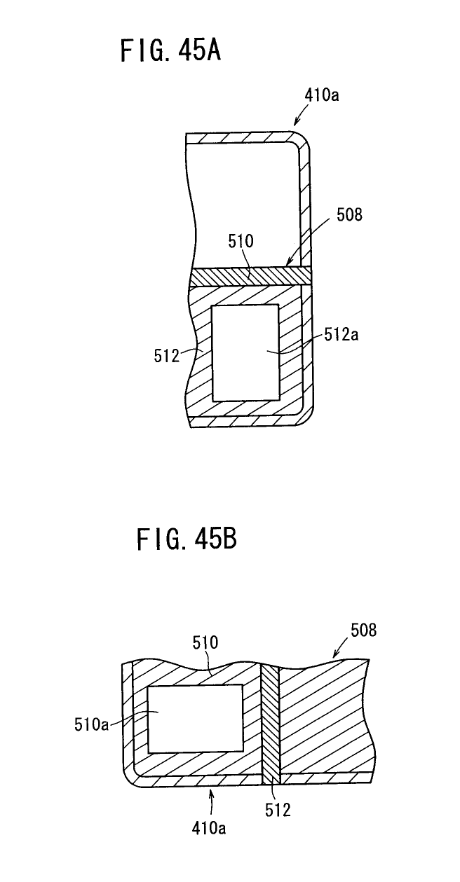

Further, as shown in FIG. 45A, on the vertical portion 512, on the lower surface side of the heater core 410a, a through hole 512a opens through which the circulated heated water can flow. Furthermore, as shown in FIG. 45B, on the planar portion 510 facing the discharge conduit 500, another through hole 510a opens through which the heated water can flow. Additionally, in the heater core 410a employing the baffle plate 508, heated water supplied from the supply conduit 498 is supplied to the interior of one of the tank portions 503a, and flows along an upper surface side of the baffle plate 508 and is supplied to one of the tubes (not shown). Additionally, after reversing in direction at the tank portion 503b disposed on the other end side of the heater core 410a, the heated water flows along the lower surface side of the baffle plate 508, and after flowing to the through hole 510a of the planar portion 510 from the through hole 512a of the vertical portion 512, the heated water is discharged from the discharge conduit 500 via the tank portion 503a.

At this time as well, since the discharge conduit 500 is connected at an upper corner portion 411a (in the rearward direction) of the heater core 410a, which is inclined at a predetermined angle, even in the case that entrapped or retained air is generated inside the heater core 410a, the air can be reliably discharged to the exterior through the discharge conduit 500, which is connected at the upper corner portion 411a where such retained air is generated.

As shown in FIG. 14, on the downstream side of the heater core 410, a fifth front passage 514 is formed. The fifth front passage 514 extends in the forward direction (in the direction of the arrow A), and at a location that merges with the third front passage 484, a temperature control damper 516 is provided, and together therewith, sub-defroster dampers 518a, 518b are disposed in an upward direction facing the heater core 410. Under a rotating action of the temperature control damper 516, a communication state between the fifth front passage 514 and the third front passage 484 is switched, for deflecting the blowing direction of warm air supplied from the fifth front passage 514 into the third front passage 484.

On the other hand, the sub-defroster dampers 518a, 518b are disposed so as to be capable of switching a communication state between the fifth front passage 514 and the sixth front passage 520 formed thereabove. By rotating the sub-defroster dampers 518a, 518b and thereby establishing communication between the fifth front passage 514 and the sixth front passage 520, i.e., by shortening the fluid passage from the fifth front passage 514 to the sixth front passage 520, warm air heated by the heater core 410 can be supplied directly to the sixth front passage 520 without flowing through the third front passage 484, in a state in which ventilation resistance of the fluid passage is reduced.

Owing thereto, in the case that a heat mode for blowing air in the vicinity of the feet of passengers, or a defroster mode for blowing air in the vicinity of the front window of the vehicle, is selected, the blowing rate can be increased to quickly heat such areas.

Stated otherwise, even without increasing the rotation of the first blower unit 406, the blowing rate of air during the heat mode and the defroster mode can be increased.

The sixth front passage 520 communicates with the downstream side of the third front passage 484 through the forwardly disposed opening, and communicates with a later-described seventh front passage 522 through the opening disposed rearward. A defroster blow-out port 524 opens upwardly of the sixth front passage 520, with a pair of defroster dampers 526a, 526b being disposed rotatably therein facing the defroster blow-out port 524.

The defroster dampers 526a, 526b are provided to switch the blowing state when the air supplied to the sixth front passage 520 is blown out from the defroster blow-out port 524, and further are capable of adjusting the blowing rate thereof.

Further, at a downstream side of the sixth front passage 520, a pair of heat dampers 528 made up from a butterfly valve are rotatably disposed (see FIG. 13). By rotating the heat dampers 528, the blowing state of air is switched, when air supplied from the sixth front passage 520 is blown out through later-described seventh and eighth front passages 522, 540 or through the defroster blow-out port 524, and further, the blowing rate of such air can be adjusted.

Further, as shown in FIG. 46, the sixth front passage 520 is divided into two sections by the center plate 420, which is disposed centrally in the casing 402 in the widthwise direction thereof. Also, the sixth front passage 520 is further divided respectively by a pair of dividing panels 530a, 530b, which are disposed roughly centrally in the widthwise direction of the first and second divided casings 416, 418. In addition, in the sixth front passage 520, between the center plate 420 and the dividing panels 530a, 530b, the pair of heat dampers 528 are disposed, such that air that flows between the center plate 420 and the dividing panels 530a, 530b is directed outwardly to a first heat passage 538 (discussed later) under rotating actions of the heat dampers 528.

On the other hand, the defroster dampers 526a, 526b are disposed respectively between the dividing panels 530a, 530b and inner wall surfaces of the first and second divided casings 416, 418, so that air that flows between the dividing panels 530a, 530b and inner wall surfaces of the first and second divided casings 416, 418 is directed outwardly, respectively, from side portions 534 of the defroster blow-out port 524 under rotating actions of the defroster dampers 526a, 526b.

More specifically, the sixth front passage 520 is divided into four sections inside the casing 402 by the pair of dividing panels 530a, 530b and the center plate 420, such that the blowing state and blowing rate of air that is blown from the defroster blow-out port 524 is switched by the defroster dampers 526a, 526b.

As shown in FIG. 47, by respectively removing covers 536a, 536b, which are disposed alongside the defroster dampers 526a, 526b and the sub-defroster dampers 518a, 518b in the first and second divided casings 416, 418, maintenance thereon, such as exchanging and adjustment of rotation angles, etc., can easily be carried out on the defroster dampers 526a, 526b and the sub-defroster dampers 518a, 518b.

The seventh front passage 522 communicates with a first heat blow-out port (not shown) through the first heat passage 538 for the purpose of blowing air in the vicinity of the feet of passengers in the front seats in the vehicle compartment. The eighth front passage 540 extends downwardly in a curving manner and communicates with a second heat blow-out port (not shown) upwardly of the second blower unit 412 through a second heat passage (not shown) for the purpose of blowing air in the vicinity of the feet of passengers in the middle seats in the vehicle compartment.

In the casing 402, the first vent blow-out port 492 and the defroster blow-out port 524 open upwardly of the casing 402, and further, the first vent blow-out port 492 is arranged on a forward side (in the direction of arrow A), whereas the defroster blow-out port 524 is arranged rearward, substantially centrally in the casing 402 with respect to the first vent blow-out port 492 (see FIG. 14).

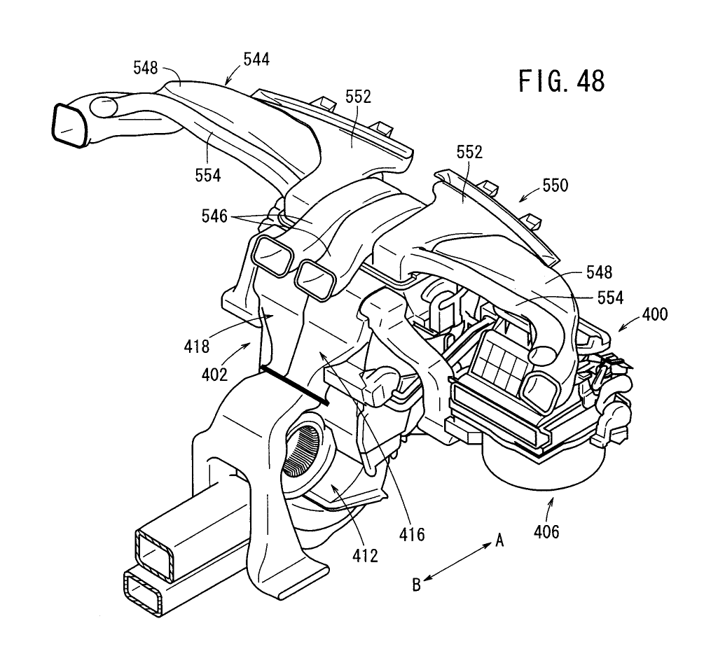

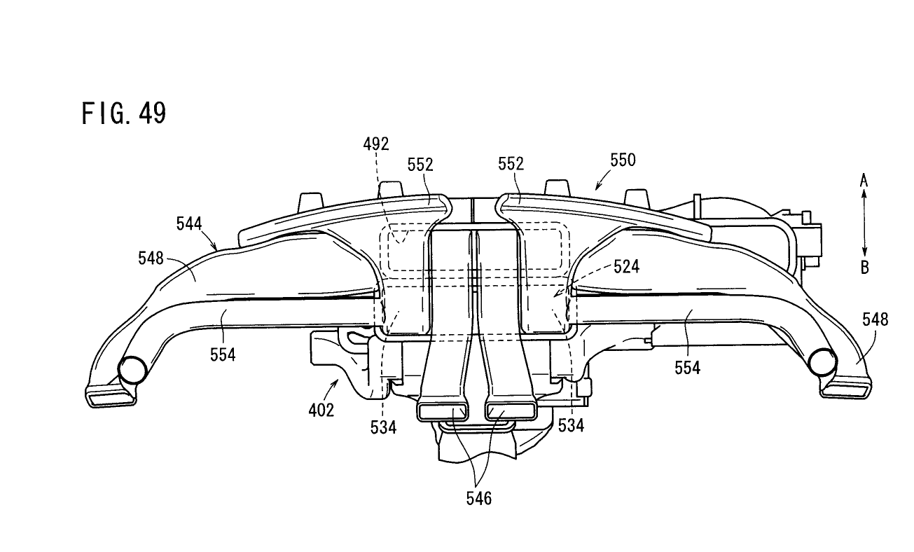

As shown in FIGS. 48 and 49, a vent duct 544, which extends while curving toward the rearward side of the vehicle (in the direction of arrow B), is connected to the first vent blow-out port 492 for supplying mixed air to the vicinity of faces of passengers in the front seats of the vehicle compartment from the first vent blow-out port 492. A pair of center vent ducts 546 that make up the vent duct 544 are connected to a center portion of the first vent blow-out port 492 and blow air toward the center of the front seats, whereas another pair of side vent ducts 548, which are connected to both ends of the first vent blow-out port 492, extend in lateral directions of the front seats, and blow air toward the driver's seat and passenger seat sides thereof.

On the other hand, a defroster duct 550, which extends while curving toward the forward side of the vehicle (in the direction of arrow A), is connected to the defroster blow-out port 524 for supplying mixed air to the vicinity of the front window in the vehicle compartment from the defroster blow-out port 524. The defroster duct 550 is constituted by center defroster ducts 552, which are branched in a forked manner so as to avoid the center vent ducts 546 that extend upwardly of the defroster blow-out port 524, and extend toward an unillustrated front window, and side defroster ducts 554, which extend perpendicularly to the center defroster ducts 552 in lateral directions together with the side vent ducts 548. The center defroster ducts 552 extend toward the forward side (in the direction of arrow A) straddling upwardly over the side vent ducts 548.

More specifically, the vent duct 544 connects to the first vent blow-out port 492 disposed on the forward side and extends rearward (in the direction of arrow B) toward the vehicle compartment, whereas the defroster duct 550 connects to the defroster blow-out port 524 disposed on the rearward side and extends in a forward direction (in the direction of arrow A) on the front window side while crossing over the vent duct 544.

In this manner, by arranging the first vent blow-out port 492 on the forward side of the casing 402, the third front passage 484 that communicates between the downstream side of the evaporator 408 and the first vent blow-out port 492 can be laid out in a straight line fashion, while the defroster blow-out port 524 can be disposed upwardly of the heater core 410.

In this case, the center defroster ducts 552 and the side defroster ducts 554 that constitute the defroster duct 550 extend respectively from the side portions 534 of the defroster blow-out port 524, such that the center vent ducts 546 are oriented and can extend rearward (in the direction of arrow B) from the first vent blow-out port 492, which is disposed forwardly (in the direction of arrow A) of the defroster blow-out port 524.

The first blower unit 406 includes an intake damper (not shown) in which an external air intake port 556 connected to a duct (not shown) for the purpose of introducing external air and an internal air intake port 558 for introducing internal air are arranged in an opening thereof, and which carries out switching between the external and internal air, and a first blower fan 560 that supplies air that is taken in to the interior of the casing 402. A blower case 562 in which the first blower fan 560 is accommodated communicates with the interior of the casing 402 through the connection duct 404 connected to the first intake port 422. Rotation of the first blower fan 560 is controlled by a fan motor (not shown), which is driven under the control of a later-mentioned rotation control device 564a.

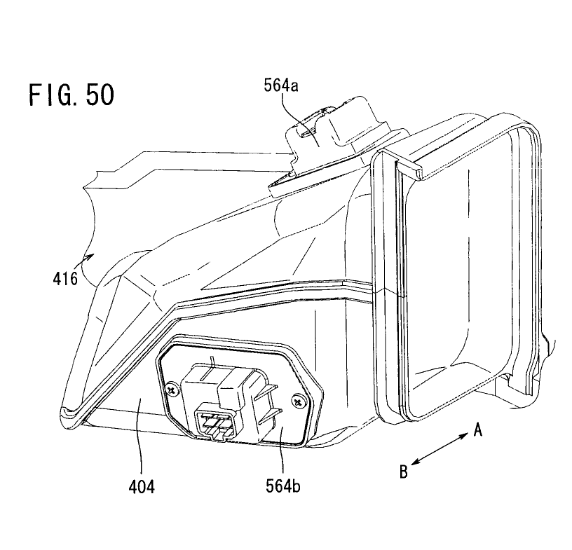

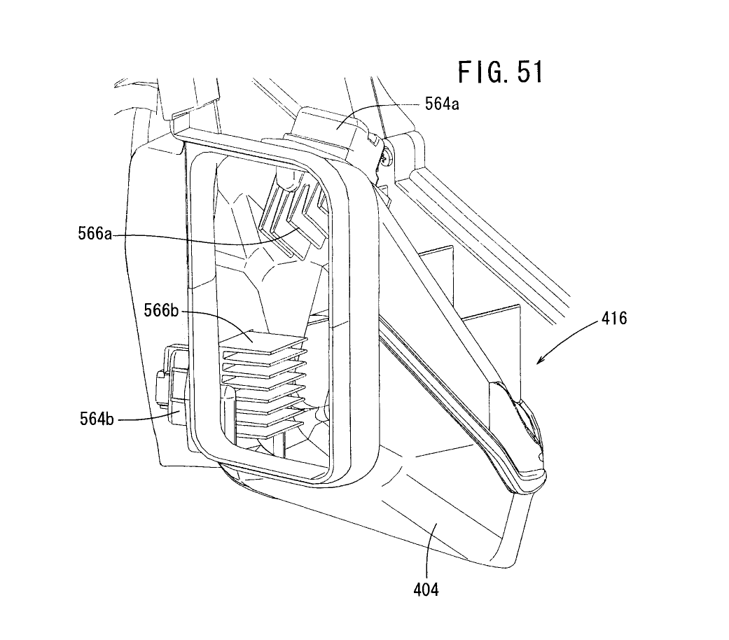

Further, the connection duct 404 has a shape in which the cross sectional area of a passage thereof is greater than a later-mentioned first rear passage 570, which forms the connection passage of the second blower unit 412. Further, as shown in FIGS. 50 and 51, the connection duct 404 is formed in a tubular shape having a substantially rectangular shape in cross section, wherein two rotation control devices 564a, 564b are installed on wall portions thereof. The rotation control devices 564a, 564b are capable of controlling the air-blowing rate to the inside of the casing 402, by controlling respectively the rotation number (rotational frequency, RPM) of the first blower fan 560 and the second blower fan 574. The rotation control devices 564a, 564b are arranged inside the connection duct 404 at positions where the fluid passage cross sectional area thereof is maximal. In addition, the rotation control devices 564a, 564b are arranged perpendicularly to each other, and a plurality of heat radiation fins 566a, 566b are mounted so as to project into the passage of the connection duct 404. Specifically, by placing the heat radiation fins 566a, 566b in contact with air that flows inside the connection duct 404, since heat generated by the rotation control devices 564a, 564b can suitably be dissipated via the heat radiation fins 566a, 566b, the rotation control devices 564a, 564b can be cooled effectively.

More specifically, air supplied from the first blower unit 406 is introduced to the interior of the casing 402 through the connection duct 404 and the first intake port 422. By rotation of the first air mixing damper 488, the vent damper 494, the defroster dampers 526a, 526b, the heat dampers 528, and the sub-defroster dampers 518a, 518b that make up the damper mechanism 414, air is selectively supplied to the defroster blow-out port 524, the first vent blow-out port 492, the first heat passage 538, and the second heat passage (not shown), which are capable of blowing air to the front seats and middle seats in the vehicle, through the first through seventh front passages 424, 482, 484, 486, 514, 520 and 522.

On the other hand, in a lower portion of the casing 402, as shown in FIGS. 13 and 14, a second intake port 568 through which air is supplied from the second blower unit 412 is formed at a rearward side perpendicular to the first intake port 422. The second intake port 568 opens at a position on an upstream side of the evaporator 408, and communicates with the first rear passage 570, and further, is formed alongside the first intake port 422 via the first rear passage 570 and the first dividing wall 572.

The second blower unit 412 includes the second blower fan 574, which supplies air that has been taken in to the interior of the casing 402. A blower case 576 in which the second blower fan 574 is accommodated is connected to the second intake port 568 of the casing 402 and communicates with the first rear passage 570. In the same manner as the first blower fan 560, rotation of the second blower fan 574 is controlled by a fan motor (not shown) driven under the control of the rotation control device 564b.

On a downstream side of the first rear passage 570, the evaporator 408 is disposed such that the second cooling section 438 thereof faces the first rear passage 570. The first dividing wall 572, which is formed between the first rear passage 570 and the first front passage 424, extends to the first and second partitioning members 464, 466 that are installed on the evaporator 408. The first partitioning member 464 is retained in the base holder 578, which is disposed at the end of the first dividing wall 572.

More specifically, since the first dividing wall 572 extends to the first and second partitioning members 464, 466 that are installed on the evaporator 408, air that flows to the evaporator 408 through the first rear passage 570 is prevented from mixing with air that flows to the evaporator 408 through the first front passage 424.

Further, a second guide panel 580 for guiding moisture ejected from the evaporator 408 to the bottom of the casing 402 is formed in the first rear passage 570 while being separated a predetermined distance from the first dividing wall 572. An upper end of the second guide panel 580 extends to the vicinity of the base holder 578 disposed on the first dividing wall 572, and is bent rearward so as to be separated a predetermined distance from the base holder 578 (see FIG. 18).

In addition, in the event that moisture generated by the second cooling section 438 of the evaporator 408 flows to the forward side (in the direction of arrow A) along the lower surface of the evaporator 408 and is retained in the first partitioning member 464 and the base holder 578, or when such moisture comes into contact with the upper end of the second guide panel 580, the moisture is guided and flows downwardly along the second guide panel 580. The moisture is then discharged from the casing 402 through a second drain port 582 disposed between the first dividing wall 572 and the second guide panel 580.

Owing thereto, condensed water that is generated in the evaporator 408 is prevented from accumulating and freezing in the evaporator 408.

On a downstream side of the evaporator 408, a second rear passage 584 is formed, to which air having passed through the second cooling section 438 of the evaporator 408 is supplied. The second rear passage 584 is separated from the second front passage 482 by a second dividing wall 586, wherein the second partitioning member 466 is retained in the base holder 588 disposed at the end of the second dividing wall 586. Specifically, because the second dividing wall 586 extends to the second partitioning member 466 installed on the evaporator 408, on the downstream side of the evaporator 408 as well, air that flows to the second cooling section 438 of the evaporator 408 through the first rear passage 570 does not intermix with air that passes through the first front passage 424 and flows to the first cooling section 436 of the evaporator 408.

In the second rear passage 584, a second air mixing damper 590 is disposed rotatably therein facing the heater core 410 for mixing cooled air and heated air at a predetermined mixing ratio to thereby produce mixed air. The second air mixing damper 590 switches the communication state between the second rear passage 584 and an upstream or downstream side of a third rear passage 592, which is connected to a downstream side of the heater core 410. Consequently, by rotating the second air mixing damper 590, cool air that is cooled by the evaporator 408 and supplied to the second rear passage 584 and warm air that is heated by the heater core 410 and which flows through the third rear passage 592 are mixed at a predetermined mixing ratio within the third rear passage 592 and blown out therefrom.

Stated otherwise, the third rear passage 592 functions as a mixing section for mixing warm air and cool air, which is then blown out to the middle seats and rear seats in the vehicle.

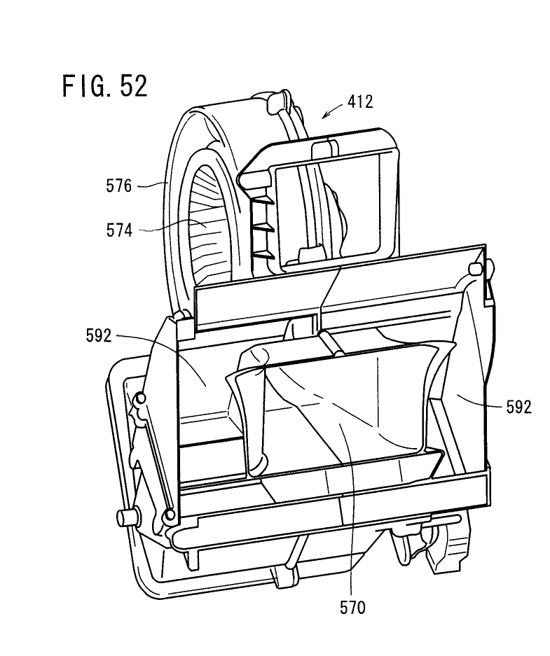

Further, as shown in FIG. 13, the third rear passage 592, after bending to circumvent the other end of the heater core 410, extends downwardly, and midway therein, an opening is formed that communicates with the second rear passage 584. On a downstream side extending further downward from the opening, as shown in FIG. 52, the third rear passage 592 branches in a forked manner, branching in widthwise directions of the casing 402 about the first rear passage 570, and after extending so as to avoid the first rear passage 570 on both sides thereof, the third rear passage 592 merges again downward of the first rear passage 570. Stated otherwise, the third rear passage 592 is formed so as to cross over the first rear passage 570.

As shown in FIGS. 13 and 14, on a downstream side of the third rear passage 592, fourth and fifth rear passages 594, 596 communicate therewith. A rotatable mode switching damper 598 is disposed at a branching location thereof, which serves to switch the blowing state of air to the fourth and fifth rear passages 594, 596, which branch respectively from the third rear passage 592, and also to adjust the blowing rate of air thereto.

The fourth and fifth rear passages 594, 596 extend toward a rearward direction of the vehicle. The fourth rear passage 594 communicates with a second vent blow-out port (not shown) for blowing air in the vicinity of faces of passengers in the middle seats of the vehicle. The fifth rear passage 596 communicates with second and third heat blow-out ports (not shown) for blowing air in the vicinity of the feet of passengers in the middle and rear seats.

Specifically, air supplied from the second blower unit 412 is directed into the casing 402 through the second intake port 568, and is selectively supplied to the second vent blow-out port, and the second and third heat blow out ports, which are arranged to face the middle seats and rear seats in the vehicle, through the first through fifth rear passages 570, 584, 592, 594, 596.

Moreover, because the aforementioned second to seventh front passages 482, 484, 486, 514, 520, 522 are divided in half at a substantially central portion of the casing 402 by the center plate 420, the second to seventh front passages 482, 484, 486, 514, 520, 522 are disposed respectively inside of the first and second divided casings 416, 418.

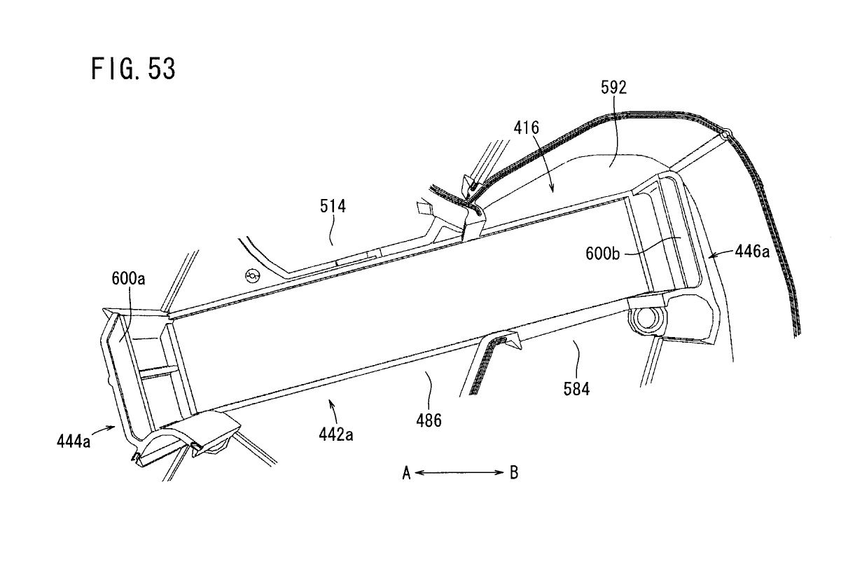

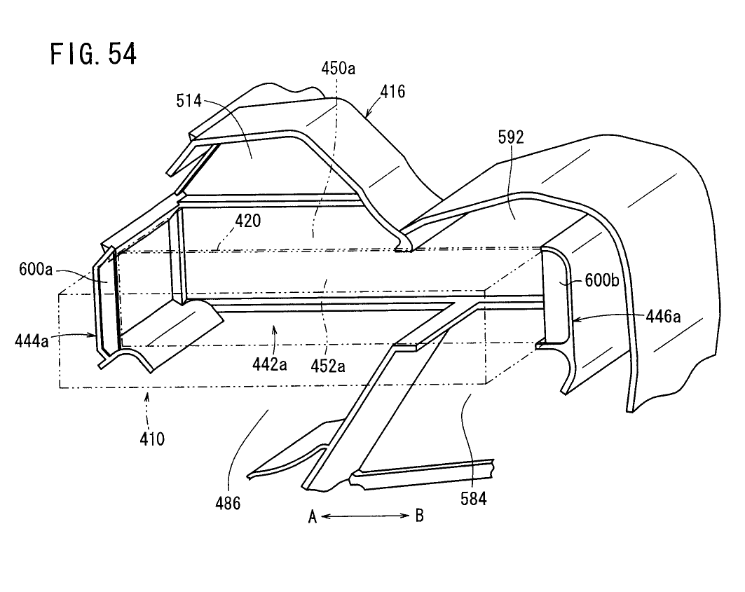

An explanation shall now be made with reference to FIGS. 53 to 55 concerning a modified example of a heater holder 442a for retaining the heater core 410 inside the casing 402.

In the heater holder 442a, a pair of ribs 600a, 600b (sealing members) are formed, which project toward and abut against the side surfaces of the heater core 410 at center portions of first and second retaining members 444a, 446a. The paired ribs 600a, 600b are disposed at a substantially central portion of the casing 402 coplanar with the center plate 420 provided in the casing 402, and extend roughly in a vertical direction. Stated otherwise, the pair of ribs 600a, 600b is disposed substantially parallel with the blowing direction of air that flows through the interior of the casing 402.

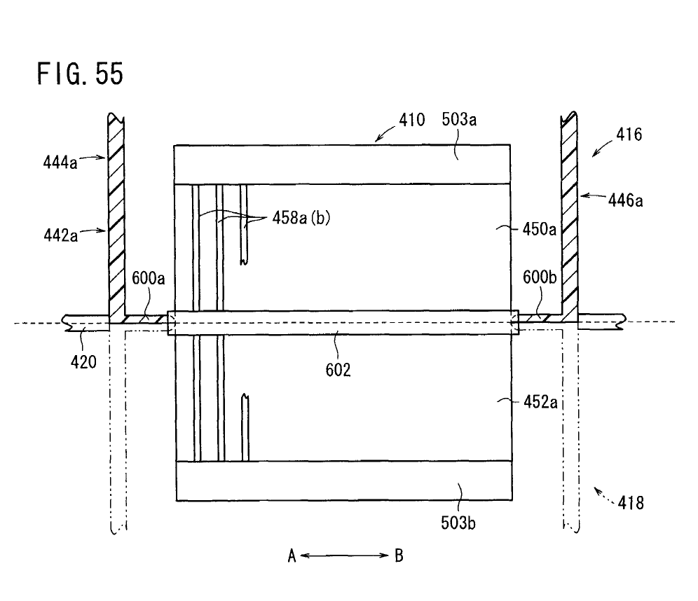

On the other hand, at a substantially center portion of the heater core 410, a partitioning means 602 is disposed along a straight line so as to unite one of the ribs 600a and the other of the ribs 600b, and further, is disposed at a position substantially coplanar with the center plate 420 provided inside the casing 402 when the heater core 410 is mounted in the heater holder 442a. The heater core 410 is separated into a first heating section 450a, which is arranged on the side of the first divided casing 416 centrally about the center plate 420 by the partitioning means 602, and a second heating section 452a, which is arranged on the side of the second divided casing 418, and prevents flow of air through the interior of the heater core 410 between the first heating section 450a and the second heating section 452a thereof (see FIG. 55).

Stated otherwise, the partitioning means 602 disposed on the heater core 410 and the pair of ribs 600a, 600b provided on the heater holder 442a are arranged perpendicularly to the first and second partitioning members 464, 466 provided on the evaporator 408, and the vertical ribs 432b, 434b in the evaporator holder 426.

In addition, air that is supplied from the first blower fan 560 and flows through the fourth front passage 486 to the heater core 410, and air that is supplied from the second blower fan 574 and flows through the second rear passage 584 to the heater core 410, are divided respectively by the partitioning means 602 into the first and second heating sections 450a, 452a, whereby such air, which is separated in the first divided casing 416 and the second divided casing 418, is heated and flows downstream. Furthermore, because the ribs 600a, 600b of the heater holder 442a are arranged along a straight line with the partitioning means 602, air that flows through the first divided casing 416 side and air that flows through the second divided casing 418 side centrally about the center plate 420 in the casing 402 are prevented from intermixing.

More specifically, after air, which has been cooled by the evaporator 408, flows through the fourth front passage 486 and the second rear passage 584, passes through the first and second heating sections 450a, 452a of the heater core 410 and is heated thereby, by supplying the air to the fifth front passage 514 and the third rear passage 592, which are separated bilaterally within the casing 402, for example, mixed air which is adjusted in temperature separately and independently is blown out respectively from the vent blow-out port on the driver's seat side and the vent blow-out port on the passenger seat side inside the vehicle compartment.

The vehicular air conditioning apparatus 400 according to the embodiment of the present invention is basically constructed as described above. Next, operations and effects of the invention shall be explained.

First, when operation of the vehicular air conditioning apparatus 400 is started, the first blower fan 560 of the first blower unit 406 is rotated under the control of the rotation control device 564a, and air (interior or exterior air) that is taken in through a duct or the like is supplied to the first front passage 424 of the casing 402 through the connection duct 404. Simultaneously, air (interior air) that is taken in by rotation of the second blower fan 574 of the second blower unit 412 under the control of the rotation control device 564b is supplied to the first rear passage 570 from the blower case 576 while passing through the second intake port 568. In the following descriptions, air supplied to the interior of the casing 402 by the first blower fan 560 shall be referred to as “first air,” and air supplied to the interior of the casing 402 by the second blower fan 574 shall be referred to as “second air.”

The first air and the second air supplied to the interior of the casing 402 are each cooled by passing respectively through the first and second cooling sections 436, 438 of the evaporator 408, and flow respectively as chilled air to the second front passage 482 and the second rear passage 584, in which the first and second air mixing dampers 488, 590 are disposed. In this case, because the interior of the evaporator 408 is divided into the first cooling section 436 and the second cooling section 438 by a non-illustrated partitioning means, the first air and the second air do not mix with one another.

Herein, in the case that a vent mode is selected by a passenger using a controller (not shown) inside the vehicle compartment for blowing air in the vicinity of the face of the passenger, by blocking communication between the second front passage 482 and the fourth front passage 486 by means of the first air mixing damper 488, the first air (cooled air) flows from the second front passage 482 to the third front passage 484. In this case, the temperature control damper 516 blocks communication between the fifth front passage 514 and the third front passage 484. Additionally, concerning the first air (cooled air) that flows to the third front passage 484, since the vent damper 494 is rotated into a position that blocks communication between the third front passage 484 and the sixth front passage 520, the first air is blown from the open first vent blow-out port 492, through the vent duct 544, and in the vicinity of the face of a passenger who rides in the front seat in the vehicle compartment.

On the other hand, concerning the second air (cooled air), since flow to the second heating section 452 of the heater core 410 is interrupted by the second air mixing damper 590, the second air flows downstream from the second rear passage 584 through the third rear passage 592. Additionally, the second air (cooled air) is blown in the vicinity of the face of a passenger who rides in the middle seat in the vehicle compartment from the second vent blow-out port (not shown) through the fourth rear passage 594 under a switching operation of the mode switching damper 598.

Further, for example, in the vent mode, in the case that the interior of the vehicle compartment is quickly cooled, the cooling vent damper 490 enables communication between the second front passage 482 and the third front passage 484. As a result, since the blowing rate of the first air (cooled air) that flows to the third front passage 484 from the second front passage 482 increases, the vehicle compartment can be cooled quickly by the first air, which is blown from the first vent blow-out port 492 through the vent duct 544.

In this case, since it is unnecessary to mix warm air supplied to the fifth front passage 514 with the cool air of the third front passage 484, the temperature control damper 516 is rotated to become substantially parallel with the third front passage 484 and to block communication between the fifth front passage 514 and the third front passage 484. As a result, cooled air in the third front passage 484 can be supplied to the first vent blow-out port 492 without being raised in temperature. In addition, because the temperature control damper 516 suppresses flow passage resistance when cool air flows through the third front passage 484, low electrical power consumption of the first blower fan 560 is realized, along with reducing noise.

Next, for example, in the case that the bi-level mode is selected by the controller (not shown) inside the vehicle compartment for blowing air in the vicinity of faces and feet of the passengers, the first air mixing damper 488 is rotated to an intermediate position between the third front passage 484 and the fourth front passage 486, so that the first air is caused to flow respectively to both the third front passage 484 and the fourth front passage 486. Furthermore, the temperature control damper 516 is rotated, whereupon air heated by the first heating section 450 of the heater core 410 is supplied into the third front passage 484 from the fifth front passage 514. At this time, the vent damper 494 is positioned at an intermediate position between the first vent blow-out port 492 and the opening of the sixth front passage 520, and together therewith, the defroster blow-out port 524 is blocked by the defroster dampers 526a, 526b, whereupon the communication opening from the fifth front passage 514 to the sixth front passage 520 is blocked by the sub-defroster dampers 518a, 518b and communication therebetween is interrupted.

Herein, the first air (cooled air) flows from the second front passage 482 to the third front passage 484. In this case, the temperature control damper 516 is oriented in a direction so as to be separated from the communication opening between the fifth front passage 514 and the third front passage 484, while the end portion thereof is rotated to face the upstream side of the third front passage 484. Specifically, the first air (cooled air) is heated by the first heating section 450 of the heater core 410, and by mixing only at a small amount with the first air (heated air) that flows to the third front passage 484 through the fifth front passage 514, air is blown directly from the first vent blow-out port 492, through the vent duct 544, and in the vicinity of the face of a passenger who rides in the front seat in the vehicle compartment.

In this case, since the temperature control damper 516 is rotated so that the end portion thereof confronts the upstream side of the third front passage 484 and projects into the third front passage 484, warm air is guided to the upstream side of the third front passage 484 along the temperature control damper 516, and further mixing thereof with cooled air can be promoted. Further, concerning the heat dampers 528 in the form of a butterfly valve, one end side thereof is rotated about the support axis to project toward the side of the sixth front passage 520 (in the direction of arrow A), while the other end side thereof is rotated to project toward the side of the seventh front passage (in the direction of arrow B).

Consequently, warm air that is mixed with cool air in the third front passage 484 flows from the sixth front passage 520, through the seventh front passage 522, and to the first heat passage 538, and is blown in the vicinity of the feet of passengers who ride in the front seat in the vehicle compartment, and together therewith, is blown in the vicinity of the feet of passengers who ride in the middle seats in the vehicle compartment, from the eighth front passage 540 and through the second heat passage (not shown).

Further, the sub-defroster dampers 518a, 518b may be rotated so as to establish communication between the fifth front passage 514 and the sixth front passage 520. As a result, air that passes through the first heating section 450 of the heater core 410 is added to the first air, which has been supplied to the sixth front passage 520 via the third front passage 484, whereupon warm first air can be supplied directly with respect to the sixth front passage 520. Owing thereto, it is possible to increase the blowing rate of warm air that is blown in the vicinity of the feet of passengers in the front seat in the vehicle compartment from the first heat blow-out port (not shown). Stated otherwise, warm air blown in the vicinity of the feet of passengers can be supplied at a more stable temperature.

On the other hand, concerning the second air (cooled air), the second air mixing damper 590 is rotated to an intermediate position whereby the second air flows to the second heating section 452 of the heater core 410, and together therewith, flows to the third rear passage 592 connected to the second rear passage 584. Specifically, the second air, after having been cooled by the second cooling section 438 of the evaporator 408, is divided in flow by the second air mixing damper 590, such that one portion is guided to the third rear passage 592 as cooled air, whereas the other portion thereof, after being heated by the second heating section 452 of the heater core 410, is blown into the third rear passage 592. As a result, the second air is adjusted to a suitable temperature in the third rear passage 592.

The angle of rotation of the second air mixing damper 590 can be freely changed in accordance with the temperature desired by passengers in the vehicle compartment, or stated otherwise, the second air mixing damper 590 can be rotated in coordination with an input from the controller in the vehicle compartment. Concerning the second air, which flows downstream through the third rear passage 592, the flow rate ratio thereof to the fourth rear passage 594 and the fifth rear passage 596 is adjusted by rotating the mode switching damper 598 to a predetermined position so that the second air flows therethrough. As a result, the second air is blown from the second vent blow-out port and the second heat blow-out port (not shown) in the vicinity of the faces of passengers in the middle seats inside the vehicle compartment, or alternatively, is blown from the second heat blow-out port and the third heat blow-out port (not shown) toward the feet of passengers in the middle seats and rear seats inside the vehicle compartment. Herein, the predetermined position of the mode switching damper 598 is defined in accordance with the set temperature and mode, which are input by a passenger from the controller inside the vehicle compartment. The set temperature and/or mode, apart from being input from the front seats, may also be input from the middle seats or the rear seats.

Next, in the case that the heat mode for performing blowing of air in the vicinity of the feet of passengers in the vehicle compartment is selected by the controller (not shown) in the vehicle compartment, compared to the case of the bi-level mode, the first air mixing damper 488 is rotated more to the side of the third front passage 484. Further, the temperature control damper 516 is rotated somewhat to establish communication between the third front passage 484 and the fifth front passage 514. Furthermore, the cooling vent damper 490 blocks communication between the second front passage 482 and the third front passage 484, and the vent damper 494 and the defroster dampers 526a, 526b are rotated respectively so that the first vent blow-out port 492 and the defroster blow-out port 524 are closed.

At this time, similar to the aforementioned bi-level mode, concerning the heat dampers 528 which are formed from a butterfly valve, one end side is rotated about the support axis to project into the sixth front passage 520 (in the direction of arrow A), whereas the other end side is rotated to project into the seventh front passage 522 (in the direction of arrow B).

As a result thereof, the heated first air that has passed through the first heating section 450 of the heater core 410 is supplied to the third front passage 484 from the fifth front passage 514. In the third front passage 484, the first air (cooled air), which has flowed in from the second front passage 482, is mixed with the first air (heated air), whereupon the mixed air passes through the sixth front passage 520 and the seventh front passage 522 and flows rearward. In addition, after being supplied to the first heat passage 538, air is blown from a non-illustrated first heat blow-out port in the vicinity of the feet of passengers riding in the front seat in the vehicle compartment, and from the eighth front passage 540 air is blown out via a non-illustrated second heat passage in the vicinity of the feet of passengers in the middle seats in the vehicle compartment.

In this case, since the end of the temperature control damper 516 is rotated toward the upstream side of the third front passage 484 projecting into the third front passage 484, the warm air is guided downstream of the third front passage 484 along the temperature control damper 516, and mixing thereof with cool air can be promoted.

Further, the sub-defroster dampers 518a, 518b may be rotated to establish communication between the fifth front passage 514 and the sixth front passage 520. In accordance therewith, air passes through the first heating section 450 of the heater core 410 and is added to the first air supplied to the sixth front passage 520 via the third front passage 484, and such heated first air can be supplied directly with respect to the sixth front passage 520. Owing thereto, the air blowing rate of warm air, which is blown in the vicinity of the feet of passengers in the front seat in the vehicle compartment from the first heat blow-out port, can be increased. Stated otherwise, warm air blown in the vicinity of the feet of passengers can be supplied at a more stable temperature.

On the other hand, compared to the case of the bi-level mode, the second air mixing damper 590 is rotated somewhat to separate away from the heater core 410, whereupon second air, which has passed through the second heating section 452 of the heater core 410, flows downstream through the third rear passage 592. By rotating the mode switching damper 598 to a position blocking the fourth rear passage 594, the second air passes through the fifth rear passage 596 and is blown in the vicinity of the feet of passengers in the middle and rear seats in the vehicle compartment from the second heat blow-out port and the third heat flow-out port (not shown).

Next, an explanation shall be made concerning a heat-defroster mode, in which by means of the controller (not shown) in the vehicle compartment, air is blown both in the vicinity of the feet of passengers in the vehicle compartment, and in the vicinity of the front window for eliminating fog (condensation) on the front window.

In the case of the heat-defroster mode, the defroster dampers 526a, 526b in the form of a butterfly valve are rotated about the support axis so as to separate from the defroster blow-out port 524, together with blocking the first vent blow-out port 492 by the vent damper 494 (refer to the broken line in FIG. 14). As a result thereof, a portion of the first air (mixed air) that is mixed in the third front passage 484 passes through the defroster blow-out port 524 and is blown in the vicinity of the front window in the vehicle compartment. Further, another portion of the first air (mixed air) passes through the sixth and seventh front passages 520, 522, and is blown in the vicinity of the feet of passengers in the front seats in the vehicle compartment through the first heat passage 538, as well as being blown in the vicinity of the feet of passengers in the middle seats in the vehicle compartment from the eighth front passage 540 through a non-illustrated second heat passage.

Further, in the heat-defroster mode, in the case that second air is blown toward the middle seats and rear seats of the vehicle compartment, since this mode is the same as the heat mode discussed above, detailed explanations thereof shall be omitted.

Lastly, the defroster mode for blowing air only in the vicinity of the front widow for eliminating fog (condensation) from the front window in the vehicle shall be described. In this case, the first air-mixing damper 488 and the cooling vent damper 490 block communication respectively between the second front passage 482 and the third front passage 484. At the same time, the vent damper 494 blocks the first vent blow-out port 492 and communication between the vent duct 544 and the third front passage 484, while the temperature control damper 516 establishes communication between the fifth front passage 514 and the third front passage 484. Further, the heat dampers 528 in the form of a butterfly valve are rotated about the support axis, so that one end thereof blocks the eighth front passage 540 and the other end thereof blocks the seventh front passage 522, respectively.

On the other hand, the sub-defroster dampers 518a, 518b and the defroster dampers 526a, 526b in the form of butterfly valves are rotated to establish communication between the fifth front passage 514, the sixth front passage 520, and the defroster blow-out port 524. As a result, warm first air that has passed through the heater core 410 is supplied from the fifth front passage 514, through the sixth front passage 520, and to the opened defroster blow-out port 524, whereby warm air is blown in the vicinity of the front window in the vehicle. In this case, the second blower unit 412 is not driven, and only the first air supplied from the first blower unit 406 is blown out.

In the foregoing manner, according to the second embodiment, the vehicular air conditioning apparatus includes the first blower unit 406, the second blower unit 412, passages through which air delivered from the first blower unit 406 and the second blower unit 412 passes, and a casing 402 in which the evaporator 408 and the heater core 410 that face toward the passages is disposed, wherein the first blower unit 406 and the second blower unit 412 are connected respectively to the casing 402 by the connection duct 404 and the first rear passage 570 (i.e., the connection passage of the second blower unit 412), and wherein the rotation control device 564a for adjusting the flow rate of air from the first blower unit 406 and the rotation control device 564b for adjusting the flow rate of air from the second blower unit 412 are disposed mutually perpendicularly on the outer side of the connection passage having the greater flow passage cross sectional area from among the connection duct 404 and the first rear passage 570, i.e., on the connection duct 404. Also, cooling devices 566a, 566b made up from fins are disposed mutually perpendicularly on inner walls of the connection duct 404 at positions corresponding to the rotation control devices 564a, 564b. In this case, the rotation control devices 564a, 564b are disposed at a location where the flow passage cross sectional area of the connection duct 404 is greatest. Owing thereto, without increasing the fluid resistance of the connection duct 404 and while keeping the fluid resistance inside the first rear passage 570 relatively small, adjustment of temperature with good efficiency inside the vehicle compartment can be enabled. Further, since the rotation control devices 564a, 564b are positioned in proximity on the same connection duct 404, ease of maintenance thereon can be greatly enhanced.

Further, the rotation control device 564a and the cooling device 566a are disposed on a first wall surface that forms the connection duct 404, whereas the rotation control device 564b and the cooling device 566b are disposed on a second wall surface perpendicular to the first wall surface. Owing thereto, even though the rotation control devices 564a, 564b are both disposed on the same connection duct 404, since the cooling devices 566a, 566b are both exposed suitably to the air that flows through the interior of the connection duct 404, the rotation control devices 564a, 564b can be cooled efficiently.

The vehicular air conditioning apparatus according to the present invention is not limited to the above-described embodiments, and it is a matter of course that various modified or additional structures could be adopted without deviating from the essence and gist of the invention as set forth in the appended claims.

What is claimed is:

1. A vehicular air conditioning apparatus including a first blower unit, a second blower unit, passages through which air delivered from the first blower unit and the second blower unit passes, and a casing in which a heat exchanger facing toward the passages is disposed,
wherein the first blower unit and the second blower unit are connected respectively to the casing by a first connection passage and a second connection passage; and
wherein respective rotation control devices for controlling rotation of the first blower unit and the second blower unit are disposed on either one of the first connection passage and the second connection passage which has a greater flow passage cross sectional area.

2. The vehicular air conditioning apparatus according to claim 1, wherein main bodies of the respective rotation control devices are disposed at different positions, mutually deviated with respect to an axis of the connection passage on an outer side of the connection passage.

3. The vehicular air conditioning apparatus according to claim 2, wherein the respective rotation control devices include cooling devices, the cooling devices being disposed on an inner side of either one of the first connection passage and the second connection passage which has a greater flow passage cross sectional area.

4. The vehicular air conditioning apparatus according to claim 3, wherein the cooling devices comprise heat radiation fins that project on the inside of the connection passage.

5. The vehicular air conditioning apparatus according to claim 4, wherein the heat radiation fins project mutually perpendicular to each other on the inside of the connection passage.

6. The vehicular air conditioning apparatus according to claim 1, wherein at least one of the rotation control devices is disposed at a location where the flow passage cross sectional area of the connection passage is greatest.
